(19) United States
(12) Patent Application Publication
(10) Pub. No.: US 2007/0164045 A1
(43) Pub. Date: Jul. 19, 2007

(54) Dual mode container

(76) Inventors: Hans L. Wydler, Bethesda, MD (US); Amy T. Potts, Westford, MA (US); J. Derek Riemer, Westford, MA (US)

Correspondence Address: SAIDMAN DESIGNLAW GROUP, 8601 GEORGIA AVE, SUITE 603, SILVER SPRING, MD, 20910, US

(21) Appl. No.: 11/650,794

(22) Filed: Jan. 8, 2007

Related U.S. Application Data
(63) Continuation-in-part of application No. 11/332,618, filed on Jan. 13, 2006.

(51) Int. Cl. B65D 35/00; B67D 1/07

(52) U.S. Cl. 222/106; 222/107; 222/192

(57) ABSTRACT

The present disclosure is directed to a container including a body defining a first opening, a second opening, and a chamber containing a substance, such as a condiment. The first and second openings are in fluid communication with the chamber. The container further includes a first closure sealing the first opening, and a peel-off second closure sealing the second opening. The container can be operated in a squeeze-application mode or a dipping mode. In the squeeze-application mode, the first closure is removed from the first opening and the container is squeezed to eject the substance. In the dipping mode, the second closure is removed from the second opening to allow access to the substance in the chamber. The first opening is substantially smaller than the second opening.

### CROSS-REFERENCE TO RELATED APPLICATIONS

This application is a continuation-in-part of our prior pending application Ser. No. 11/332,618, filed Jan. 13, 2006, which is incorporated by reference herein in its entirety.

### BACKGROUND OF THE DISCLOSURE

1. Field of The Disclosure

This disclosure relates to a container and, more particularly, to a container for a substance uniquely configured to operate in two modes, either a squeeze-application mode or a dipping mode.

2. Description of Related Art

Disposable condiment containers are well known. Currently, fast food establishments and the food service industry in general rely on three basic designs—foil packets, plastic cups with foil lids, and plastic cups with separate plastic Lids. These three designs account for the vast majority of disposable condiment containers sold in the U.S. and typically hold condiments, such as ketchup, mustard, mayonnaise, salad dressing, BBQ sauce, and the like.

Foil packets, although lightweight and inexpensive to produce, are problematic. The largest problem with these packets is that they are messy to use. Typically, a user rips a small opening into one end of the packet to access the condiment. The size of this opening can be informed by perforations and tear instructions, but the size of the opening is generally difficult to control. The condiment is then squeezed out of the packet on to a food product or a food wrapper, plate, or tray. If the packet is held stationery and squeezed, the condiment is forced out in a wide circular mass. If the packet is moved and squeezed, the condiment is forced out in a line. In either scenario, to express all of the condiment out of the packet, the customer has to squeeze from the bottom toward the top. Because the user must apply force toward the opening and due to the uncontrollable nature of the container, the customer may get the condiment on his or her person or clothing which is highly undesirable.

Another problem with foil packets is that they are not conducive for dipping foods. Theoretically, a consumer could rip a large end portion of the packet off to enable dipping. Since these packets are not designed to stand up on their own, the consumer might use one hand to support the packet and the other hand to dip. This is next to impossible to accomplish neatly when the consumer is dining outside of the restaurant, and awkward at best when seated at a dining table. Foods that are not long and skinny create an additional challenge (e.g. chicken nuggets, onion rings, etc.) as they will not fit in the narrow end of the foil packet.

Most consumers resolve the dipping issue by opening several foil packets and squeezing the contents out to create a large pile of the condiment somewhere on the food wrapper, plate or tray. Then, the user dips the food into the pile. This leaves a wet area of condiment where the pile is located, and also a large pile of used foil packets—either of which can soil the table, chair, the user's person or clothing. This method also requires additional clean up, which is undesirable.

Yet another problem with foil packet is that they encourage waste. The foil packets typically hold about a third of an ounce of the condiment. This amount is usually insufficient for one meal. Consumers compensate by typically grabbing a handful of packets so that they have more than enough for their needs. Unused packets usually end up in the trash.

Lastly, foil packets are problematic because they can be difficult to transport. This difficulty is due to the packets being easily capable of rupture en route.

Plastic cups with foil lids are also lightweight and inexpensive to produce. These containers resolve some of the issues described above with respect to foil packets. For example, they are more durable and therefore easier to transport. In addition, since they are typically larger and more substantial than foil packets, a consumer is less likely to a) grab more than they need; and b) discard unused ones. This may result in reduced waste. Finally, these cups work well for dipping foods.

Plastic cups with foil lids are problematic, however, because they do not work well when trying to apply their contents onto food, such as a hot dog or hamburger. In order to do so, the contents of the cups must be poured from the cup. Since many condiments simply do not pour well due to their increased viscosity, this application often must be done with a utensil.

Plastic cups with separate plastic lids, are also lightweight and inexpensive to produce. These containers resolve some of the issues described above with respect to foil packets but present other issues. For example, these cups work well for dipping foods but poorly for applying their contents to food similar to the plastic cups with foil lids. In addition, these containers require consumers to fill them at the restaurant from a pump dispenser of condiment. This may reduce cost and encourage less waste, but can be unsanitary since the cups, lids and pump are all exposed to their environment. Also, the shelf life of the condiment is limited since these containers are not airtight. Furthermore, since the plastic lids are only moderately secure on the cups, transport of these containers outside of the restaurant can result in a lid falling off causing a messy spill.

Thus, a need exists for an inexpensive condiment container that is robust, easy to transport, reduces waste, and facilitates neat use with various food products.

### SUMMARY OF THE DISCLOSURE

According to one example, the present container comprises a body that includes a bottom wall and a sidewall extending from the bottom wall. The bottom wall and sidewall define a chamber for containing a substance. The body has first and second openings in fluid communication with the chamber. The first opening is in direct contact with the chamber and is defined in the sidewall. A portion of the body is pliant. The container further comprises a first lid portion and a second lid portion. The first lid portion is operatively associated with the first opening in a closed position. The second lid portion is removably operatively associated with the second opening in a closed position. The first and second lid portions are formed of a single piece of material such that selective movement of the first lid portion moves the second lid portion from a closed position to an open position by peeling the second lid portion from the body. In a first mode, the first lid portion is in an open position, the first opening is unsealed such that the substance flows from the first opening. In a second mode, the second lid portion is in the open position, the second opening is unsealed such that the substance is accessible in the chamber.

According to one aspect, in the first mode the container has a first orientation and in the second mode the container has a second orientation different from the first orientation.

According to another aspect, in the first mode the flow is assisted by a user squeezing the body to eject the substance or the substance is poured or shaken from the container.

According to one example, the body further includes a flange extending outwardly from the sidewall. The first and second lid portions are removably connected to the flange.

According to another example, the sidewall includes a weakened area to allow a lower compressive force during squeezing to evacuate the substance.

In another example, the bottom wall and the sidewall are formed of a single piece of material.

In an additional example, moving the second Lid portion from the closed position to the open position occurs after moving the first lid portion from the closed position to the open position.

By way of example, the body further includes a spout and a weakened area. The spout extends outwardly from sidewall into the flange and defines the first opening through the sidewall. The weakened area divides a tab portion of the flange from the remainder of the flange and the weakened area divides the spout into first and second spout portions. A first closure includes the first lid portion, the first spout portion, and the tab portion. The first closure seals the first opening in a closed position. Opening the first closure moves the first spout portion out of contact with the second spout portion and moves the tab portion out of contact with the remainder of the flange. When the first closure is in an open position, the first opening is unsealed such that squeezing the body ejects the substance from the first opening. When the second lid portion is in an open position, the second opening is unsealed such that the substance is accessible in the chamber.

In such example, the sidewall may include a weakened area to allow a Lower compressive force during squeezing of to evacuate the substance.

In another example, the first and second lid portions extend in one plane. According to one example, the present container comprises an integrally formed body and a Lid defining a first closure. The body includes a spaced bottom wall and a sidewall extends from the bottom wall. The bottom wall and sidewall define a chamber for containing a substance. The body has first and second openings in fluid communication with the chamber. The body also has a flange outwardly extending from the sidewall and a spout defining the first opening. The spout outwardly extending from the sidewall into the flange.

According to yet another example, the present container comprises a body, a first closure and a second closure. The body includes a top wall, a spaced bottom watt and a sidewall joining the top and bottom watts. The bottom wall and sidewall define a chamber for containing a substance. The body has first and second openings in fluid communication with the chamber, and a portion of the body is pliant. The first closure seals the first opening in a closed position. The top wall comprises the second closure which seals the second opening in a closed position. When the first closure is in an open position, the first opening is unseated such that squeezing the body ejects the substance from the first opening. When the second closure is in an open position, the second opening is unseated such that the substance is accessible in the chamber.

According to one aspect, the first opening is in the sidewall of the body and the second opening is in the top wall of the body.

According to another aspect, the top wall further comprises a lid portion of the first closure, and the lid portion and the second closure are integrally formed. Additionally, the body may further include a flange outwardly extending from the sidewall and a spout defining the first opening. The spout extends outwardly from the sidewall into the flange.

According to yet another aspect, in one example the flange includes a weakened area for unsealing the first opening defined by the spout.

Additionally, in another example the first closure includes a lid portion, a spout portion, and a flange portion. The lid portion and the second closure may extend generally in one plane.

According to an additional example, the container may further include a sealing surface defined where the lid portion joins the body and where the second closure joins the body. The sealing surface may be in one plane.

According to one aspect, the first opening has a first shape. Upon squeezing the body, the first opening changes from a first shape to a second shape.

According to another aspect, the first closure and second closure comprise an integrally formed lid. In such an example, in a first position the first closure is in the open position and in a second position the second closure is in the open position. Moving the integrally formed lid from the first position to the second position occurs in sequence.

In one example, the first and/or second closures are frangible.

According to another example, the present container comprises a body, a first closure and a second closure. The body includes a top wall, a spaced bottom wall and a sidewall joining the top and bottom walls. The bottom wall and sidewall define a chamber for containing a substance. The body has first and second openings in fluid communication with the chamber and a portion of the body is pliant. The first opening is substantially smaller than the second opening. The first closure seals the first opening in a closed position. The top wall comprises a second closure which seals the second opening in a closed position. When the first closure is in an open position, the first opening is unsealed such that squeezing the body ejects the substance from the first opening. When the second closure is in an open position, the second opening is unsealed such that the substance is accessible in the chamber.

According to yet another example, the present container houses a condiment for use in food service and the like. The container is adapted to provide a dipping opening and an applicator opening. The dipping opening for dipping food products such as French fries in the condiment and the applicator opening for applying the condiment to a food product such as a hamburger. The container comprises a body, a first closure, and a second closure. The body includes a top wall, a spaced bottom wall and a sidewall joining the top and bottom walls. The bottom wall and sidewall define a chamber for containing the condiment. The body has the applicator and dipping openings in fluid communication with the chamber and a portion of the body is pliant. The applicator opening is substantially smaller than the dipping opening. The first closure seals the applicator opening in a closed position. The top wall comprises a second closure which seals the dipping opening in a closed position. When the first closure is in an open position, the applicator opening is unsealed such that squeezing the body ejects the condiment from the applicator opening. When the second closure is in an open position, the dipping opening is unsealed such that the condiment substance is accessible in the chamber.

### BRIEF DESCRIPTION OF THE DRAWINGS

The claims will be more fully appreciated as the same becomes better understood from the following detailed description when viewed in conjunction with the accompanying drawings, in which:

FIGS. 1-3 are side, front, and top views, respectively, of a first example of a container;

FIGS. 4 and 5 are perspective views of the container of FIG. 1 in a squeeze-application mode and in a dipping mode, respectively;

FIGS. 5A-5B are perspective views of a second example of a container;

FIGS. 5C-5D are top and close-up views of the container of FIG. 5A;

FIGS. 5E-5F are cross-sectional of the container of FIG. 5C along lines 5F-5F and 5G-5G of FIG. 5C, respectively;

FIGS. 5G-5H and 51 are perspective views of the container of FIG. 5A in a squeeze-application mode and in a dipping mode, respectively;

FIGS. 6 and 7 are exploded, perspective and side views, respectively, of a third example of a container;

FIGS. 8 and 9 are exploded, perspective and side views, respectively, of a fourth example of a container;

FIGS. 10-12 are side, front, and bottom views, respectively, of a fifth example of a container;

FIGS. 13 and 14 are perspective views of the container of FIG. 10 in a dipping mode and in a squeeze-application mode, respectively;

FIGS. 15 and 16 are perspective and top views, respectively, of a sixth example of a container in a squeeze-application mode;

FIGS. 17 and 18 are perspective views of the container of FIG. 15 showing how to convert the container into a dipping mode and in a dipping mode, respectively;

FIGS. 19-21 are perspective, front, and side views, respectively, of a seventh example of a container;

FIGS. 22 and 23 are perspective views of the container of FIG. 19 in a squeeze-application mode and in a dipping mode, respectively;

FIG. 24 is a perspective view of an eighth example of a container;

FIGS. 25 and 26 are perspective views of the container of FIG. 24 in a squeeze-application mode and in a dipping mode, respectively;

FIG. 27 is an enlarged, perspective view of a ninth example of a container;

FIGS. 28 and 29 are perspective views of the container of FIG. 27 in a squeeze-application mode and in a dipping mode, respectively;

FIG. 30 is a perspective view of a tenth example of a container;

FIG. 31 is a perspective view of the container of FIG. 30 in a squeeze-application mode;

FIGS. 32 and 33 are perspective views of the container of FIG. 30 showing how to convert the container into a dipping mode and in a dipping mode, respectively;

FIG. 34 is a perspective view of an eleventh example of a container;

FIG. 35 is a perspective view of the container of FIG. 34 in a dipping mode;

FIG. 36 is a perspective view of a twelth example of a container;

FIGS. 37 and 38 are perspective views of the container of FIG. 36 in a squeeze-application mode and in a dipping mode, respectively;

FIGS. 39 and 40 are exploded, perspective and cross-sectional views of a thirteenth example of a container;

FIG. 41 is an exploded, perspective view of a fourteenth example of a container;

FIG. 42 is a perspective view of a fifteenth example of a container;

FIGS. 43 and 44 are perspective views of the container of FIG. 42 in a squeeze-application mode and in a dipping mode, respectively;

FIGS. 45 and 46 are perspective views of a sixteenth example of a container in a squeeze-application mode and in a dipping mode, respectively;

FIG. 47 is an exploded, perspective view of a seventeenth example of a container;

FIG. 48 is a perspective view of the container of FIG. 47 in a squeeze-application and a dipping mode;

FIGS. 49 and 50 are perspective and side views, respectively, of several containers of FIG. 47 stacked;

FIGS. 51 and 52 are side views of eighteenth examples of containers capable of improving bulk packaging;

FIG. 53 is an exploded, perspective view of a nineteenth example of a container;

FIGS. 54 and 55 are perspective views of the container of FIG. 53 in a squeeze-application mode and in a dipping mode, respectively;

FIGS. 56-60 are perspective views of a twentieth example of a container;

FIGS. 61-63 are perspective views of a twenty-first example of a container;

FIGS. 64-66 are perspective views of a twenty-second example of a container;

FIGS. 67-69 are perspective views of a twenty-third example of a container;

FIGS. 70-72 are top view and two perspective views, respectively, of a twenty-fourth example of a container;

FIGS. 73-74 are top and perspective views, respectively, of a twenty-fifth example of a container;

FIG. 75 is a partial close-up cross-sectional view of the container of FIGS. 73-74;

FIGS. 76-78 are side, top and perspective views, respectively, of a twenty-sixth example of a container;

FIGS. 79-81 are side, top and perspective views, respectively, of a twenty-seventh example of a container;

FIGS. 82-85 are side and top views, respectively, of a twenty-eighth example of a container;

FIGS. 87-88 are perspective views of the container of FIGS. 85-86;

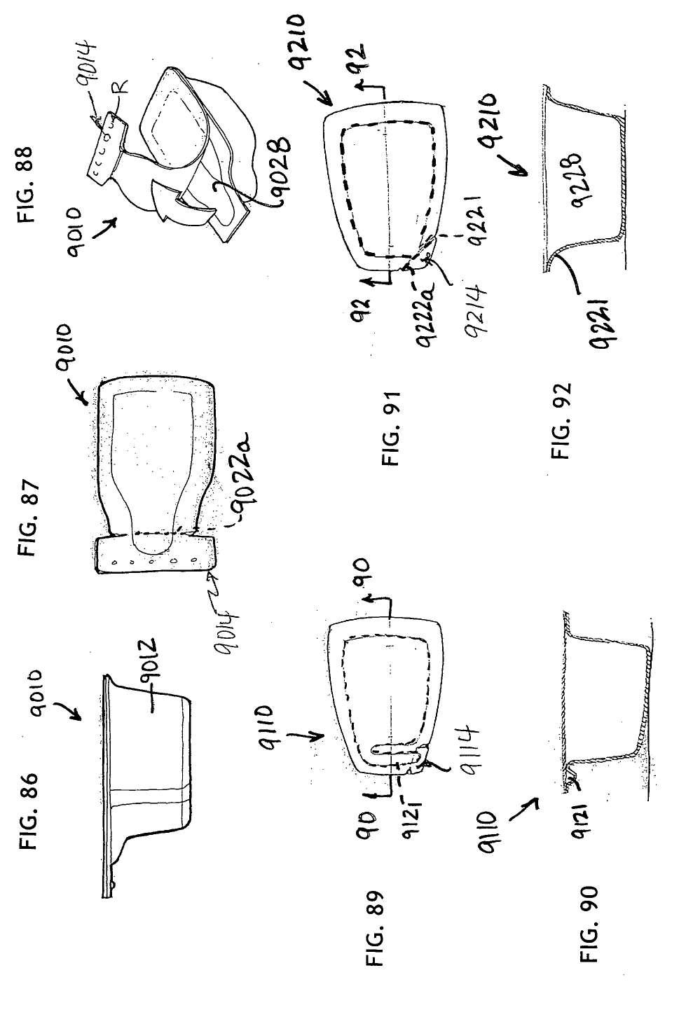

FIGS. 86-88 are side, top and perspective views, respectively, of a twenty-ninth example of a container;

FIGS. 89 is top of the a thirtieth example of a container;

FIGS. 90 is a cross-sectional view of the container of FIG. 89 along lines 90-90 of FIG. 89;

FIGS. 91 is top of a thirty-first example of a container; and

FIGS. 92 is a cross-sectional view of the container of FIG. 91 along lines 92-92 of FIG. 91.

### DETAILED DESCRIPTION

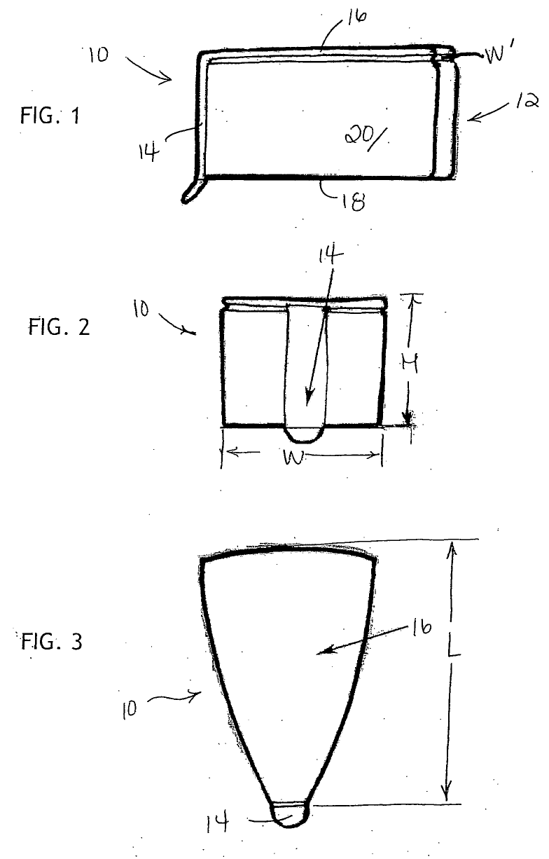

Referring to FIGS. 1-3, first exemplary container 10 is illustrated. Container 10 comprises body 12, first closure or movable lid 14 and second closure or movable lid 16, which is part of body 12 as discussed below. First closure or lid 14 and second closure or lid 16 are located in different planes and seated in different planes.

Referring to FIGS. 1, 4, and 5, body 12 includes top watt or second closure 16, bottom wall 18 and outwardly extending sidewall 20 so that chamber 22 is defined thereby. Chamber 22 contains substance 24. Sidewall 20 further includes first opening 26 and sidewall 20 also defines second opening 28. First and second openings 26 and 28 are in fluid communication with chamber 22. Sidewall 20 may include an optional weakened area W′ (see FIG. 1) at the top edge to allow second lid 16 to be easily removed.

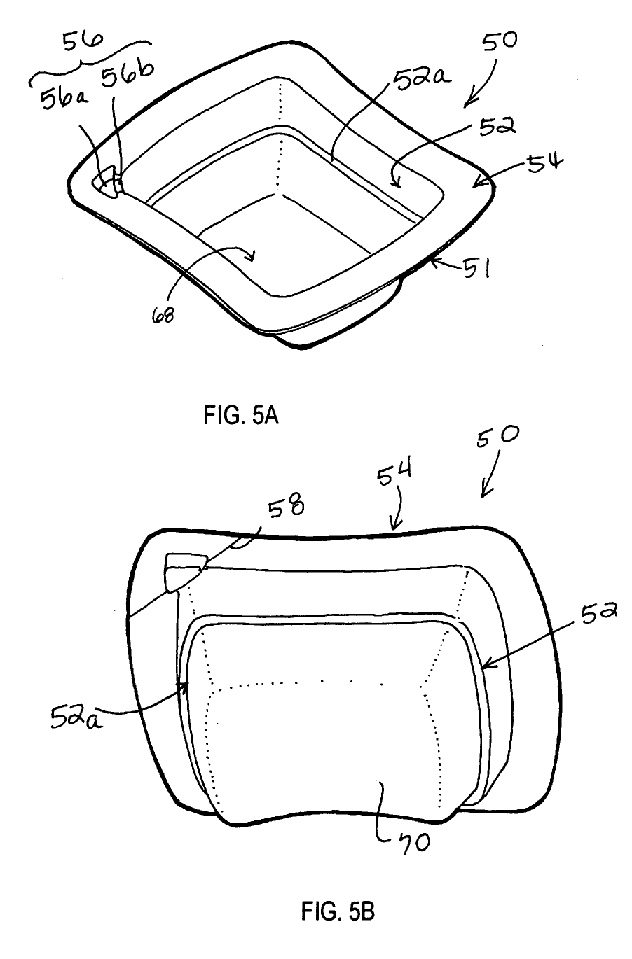

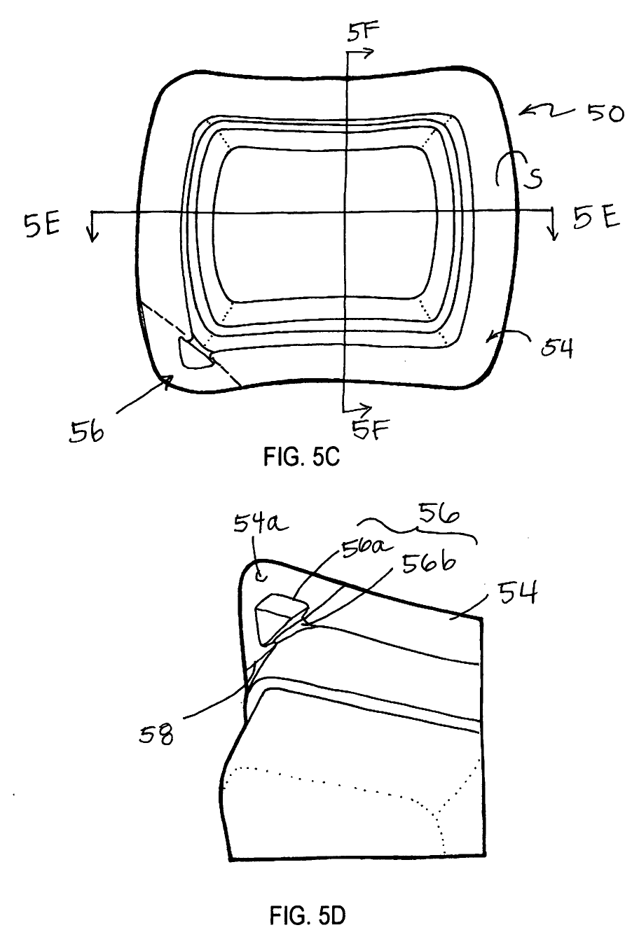

Referring to FIGS. 1 and 5, first movable lid 14 is operatively associated with or seats first opening 26 in a closed position (as shown in FIG. 1). Second movable lid 16 is operatively associated with or seats second opening 28 in a closed position (as shown in FIG. 1).

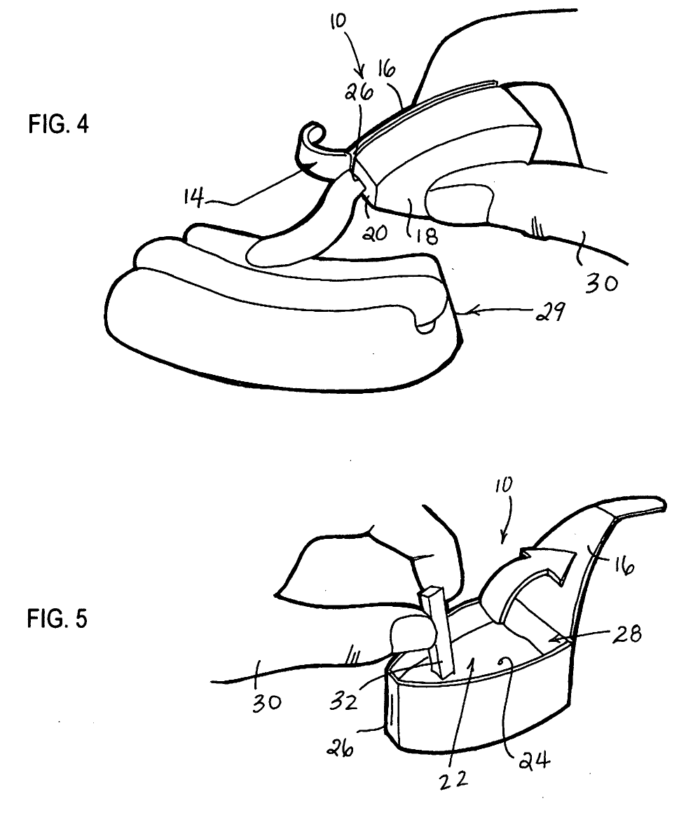

First movable lid 14 is shown in an open position in FIG. 4. In this position container 10 can be operated in a squeeze-application mode. First opening 26 is unsealed. When user 30 squeezes body 12 by applying a force on lid 16, sidewall 20 and bottom wall 18, container 10 compresses and substance 24 ejects from first opening 26. First opening 26 is formed such that a predetermined pressure is necessary to open first opening 26. When the predetermined pressure is applied by squeezing, first opening 26 changes shape, for example, from a slit to a puckered opening. The predetermined pressure threshold helps prevent substance 24 from leaking out of opening 26 without squeeze action. In an alternative example, a valve such as a duckbill valve can be added to first opening 26 to prevent undesired leaking.

Body 12 and lid 16 are formed of a material pliant enough to allow such compression and to allow such operation of first opening 26. One or more of lid 16, bottom wall 18 and sidewall 20 may be flexible for the use of container 10 in the squeeze-application mode. As a result, user 30 can squeeze substance 24 onto a food product, such as hot dog 29 or hamburger. Utilizing the squeeze-application mode allows user 30 to accurately or precisely apply substance 24.

First and second lids 14 and 16 are not independent. As a result, to open second Lid 16 first lid 14 must also be opened. Second movable lid 16 is shown in an open position in FIG. 5. In this position, container 10 can be operated in a dipping mode.

In container 10, first and second lids 14 and 16 are an integrally formed lid. In a first position, first lid 14 is in an open position and in a second position second lid 16 is in an open position, and moving the integrally formed lid from the first position to the second position occurs in sequence by peeling back first and second lids 14 and 16 in order.

In the dipping mode, second opening 28 is unsealed such that substance 24 is accessible in chamber 22. As a result, user 30 can dip a food product, such as French fry 32, into substance 24 before eating it. Food products, such as onion rings, chicken nuggets, chicken wings, fish fingers, fish sticks, whole or sliced vegetables, shrimp, and the like can also be dipped into second opening 28.

First opening 26 is substantially smaller than second opening 28. In container 10, for example, first opening 26 is about 1% to about 20% the size of second opening 28. In container 10 (See FIG. 1), the size of first opening 26 is generally in the lower end of the about 1% to about 20% range.

In squeeze or first mode, container 10 is operated by opening first opening 20 and locating container 10 in first orientation (See FIG. 4) where first opening is sidewardly directed and substance 24 flows from first opening 20 with the assist of the user squeezing container 10. In first mode, second opening 22 is also oriented sidewardly. In dipping or second mode, container 10 is operated by opening second opening 22 and locating container 10 in second orientation (See FIG. 5) different from first orientation so that second opening 22 is upwardly oriented or extending. In second orientation, substance 24 cannot flow from second opening 22. If substance 24 is powder or granular, in first mode substance 24 can flow with only the assistance of gravity without squeezing.

In the present example, first and second Lids 14 and 16 are removably joined to body 12 and are intergrally formed. Alternatively, first and second lids 14 and 16 can be formed as separate pieces.

In the present example, body 12 and first and second lids 14 and 16 are formed of two different materials, however in an alternative example, they can be formed of the same materials. Body 12 is formed of soft plastic, such as polyethylene for squeezing. Body 12 may be formed by injection molding or other processes know by those of ordinary skill in the art. Features, such as opening 26 may be formed during molding. This body material is also rigid enough to allow container 10 to stand up and support itself and its contents.

First and second lids 14 and 16 are formed of foil or coated paper and connected to body 12 using an adhesive. Substance 24 may be, for example, a condiment like sauce, ketchup, mustard, relish, syrup, mayonnaise, hot sauce. Substance 24 is not limited hereto and other food, non-food, medical and industrial substances. For example, substance can be syrups, creams, cheeses, detergents, cleaners, toothpaste, medications, glues, cosmetics, lotions, shampoos, paints, car care products such as wax, hand sanitizer, or the like can be used. In addition, exemplary substances include powders or grandular substances such as spices like salt, pepper and OLD BAY® Seasoning. Substance 24 can be flowable that is capable of flowing. Thus, substance 24 may have lower viscosity (i.e., liquids), such as salad dressings or higher viscosity. Exemplary higher viscosity substances include ketchup, syrup, lotions, or gels, such as jelly. Substance 24 can be heterogeneous, such as relish, or homogeneous, such as mustard or the like. Substance 24 is not limited to the exemplary substances disclosed.

When container 10 stores a powder or grandular substance, container 10 can function in two modes (a flow or first mode and a dipping or second mode). In the flow mode, lid 14 is opened as in squeeze mode and container 10 is oriented with first opening 26 downwardly directed so that gravity can cause substance 24 to be poured or shaken therefrom. When pouring or shaking the user does not assist flow with squeezing container 10.

The materials and joinder methods for container 10 may allow container 10 to be disposable and may meet the requirements for safely containing products, such as foods, cosmetics or chemicals.

Weakened area W′ (See FIG. 1) can be weakened with techniques known by those of ordinary skill in the art and is not limited to the following examples. One way to weaken area W′ is by forming area W′ with a thickness less than the thickness of the remainder of the container. Alternatively, area W′ can be scored or perforated for weakening. If such container were a single piece construction primarily of coated paper with a foil backing, area W′ may be weakened by forming area W′ of only foil without the paper backing.

Alternatively, container 10 can be formed as one piece of blow molded plastic. In an alternative example, container 10 can be two separate parts (lid 16 and body 20). Such lid 16 can be adhered to be peeled away during use.

Referring to FIGS. 2 and 3, container 10 may be dimension such that it has a length L of about 2 inches, a maximum width W of about 1.25 inches, and a height H of about 1 inch. These dimensions result in container 10 having an approximate volume of about 1 ounce, which is about three times the volume of prior art foil condiment packets. These dimensions and volume are exemplary and the present container is not limited hereto and may have other dimensions or volume as designed by one of ordinary skill in the art.

In FIGS. 5A-5G, second exemplary container 50 is shown. Container 50 includes body 51 with sidewall 52 and flange 54 extending outwardly therefrom. Spout 56 extends outwardly from sidewall 52 into flange 54. Lower surface of flange 54 (best seen in FIG. 5D) includes locally weakened score line or weakened area 58 that bisects spout 56 into first spout portion 56a and second spout portion 56b.

In the present example, spout 56 is shaped like an arrow to provide a visual cue of the squeeze-mode functionality of container 50. Arrow-shape also provides a useful grip to facilitate, opening first closure 62. Second spout portion 56b is narrowed as compared to first spout portion 56a so that a neck is provided that also facilitates opening first closure 62. The size of second spout portion 56b can be modified to accommodate substances 24 (See FIG. 4) of different viscosities. As the viscosity of substance 24 increases, the size of the second spout portion 56b also increases.

Referring to FIGS. 5A and 5G, container 50 is for use with integrally formed lid 60 with first lid portion 60a and second lid portion 60b. Container 50 includes first closure 62 with first spout portion 56a, movable tab portion 54a of flange 54, and first lid portion 60a. First lid portion 60a overlies spout portions 56a-b and flange portion 54a. Weakened area 58 can be weakened using various techniques known by those of ordinary skill in the art such as scoring or perforation.

First closure 62 is operatively associated with first opening 64 (See FIG. 5G) or seals first opening 64. Second closure or second lid portion 60b is operatively associated with second opening 68 (See FIG. 51) or overlies and aids in sealing second opening 68. Second opening 68 extends up to where first lid portion 60a lies. First lid portion 60a and second closure 60b (i.e., second lid portion) are integrally formed from a single piece of material. As a result, the lid is formed of first lid portion 60a and second closure or second lid portion 60b. In addition, first lid portion 60a and second closure 60b extend generally in one plane for ease of manufacture. Referring to FIG. 5G, spout 56a,b is formed at the top of sidewall 52 so that first lid portion 60a and second closure 60b can be integrally formed and seated in one plane.

Referring to FIG. 5C, flange 54 provides sealing surface S for first lid portion 60a and second closure 60b. Seating surface S is defined where first lid portion 60a and second closure 60b join flange 54. Sealing surface S is generally located in a single plane. A visible indicia I may be included between first lid portion 60a and second closure 60b to give the user a visual cue of how to open container 50. Flange 54 is sized so that when first lid portion 60a and second closure 60b are joined thereto, sealing surface S between these components is sufficient to retain first lid portion 60a and second closure 60b on container 50 during squeeze mode. In the present example, sealing surface S is significantly wide as compared to size of the lid so that stability/strength is provided to the seal to prevent accidental evacuation of substance 24 (See FIG. 1) during squeeze mode.

One or more of first Lid portion 60a, second closure 60b, bottom wall 70, and sidewall 52 may be flexible for the use of container 50 in the squeeze-application mode (as shown in FIG. 5H). Referring to FIGS. 5E-5F, sidewall 52 is formed with bends to define groove 52a which is a locally weakened area to allow sidewall 52 to be crushed, pliant or flexible during squeeze-application mode. During squeezing, upper and lower portions of sidewall 52 divided by groove 52a can move with respect to one another making container 50 pliant.

Bottom wall 70 optionally has a concave shape (See FIG. 5E) so that a user's thumb or index finger fits on bottom wall 70 for ease of use.

For container 50, user selects use in squeeze-application mode or dipping mode. To use container 50 in squeeze-application mode, the user bends first closure 62 along weakened area 58 to separate spout portions 56a and 56b (as shown in FIG. 5E). Thus, first opening 64 is unsealed. User then applies force on second closure 60b and bottom wall 70, as shown in FIG. 5H to squeeze condiment C from within container 50. Alternatively, container 50 can be used in dipping mode, the user moves closure 60a in direction D1 (See FIG. 51) to access substance in via second opening 68 by dipping. A user can use container 50 in squeeze application mode first then convert container 50 into dipping mode.

In the present example, body 51 is formed of a soft plastic like polystyrene, Polypropylene or polyester, or an environmentally-friendly material. Examples of environmentally-friendly materials include biodegradable materials and/or recycled material. Some exemplary biodegradable materials are polylactic acid, polylactide polymers, and/or cornstarch polymers. Such materials may include a non-reactive barrier layer.

Container 50 further includes foil lid formed of lid portions 60a and 60b. Other materials can also be used such as propylene, nylon, or environmentally friendly materials combined for example with a foil layer.

The present lid portions 60a and 60b are peelably connected to body 51 with an adhesive with a strength that allows peeling or removal from body 51. Using techniques known by those of ordinary skill in the art a sheet with a plurality of bodies 51 are vacuum formed therein and on a separate sheet a plurality of lid portions 60a, 60b can be formed. In one example, the adhesive is heat activated however other types of adhesives can be used. As a result, multiple containers 50 are formed at a time.

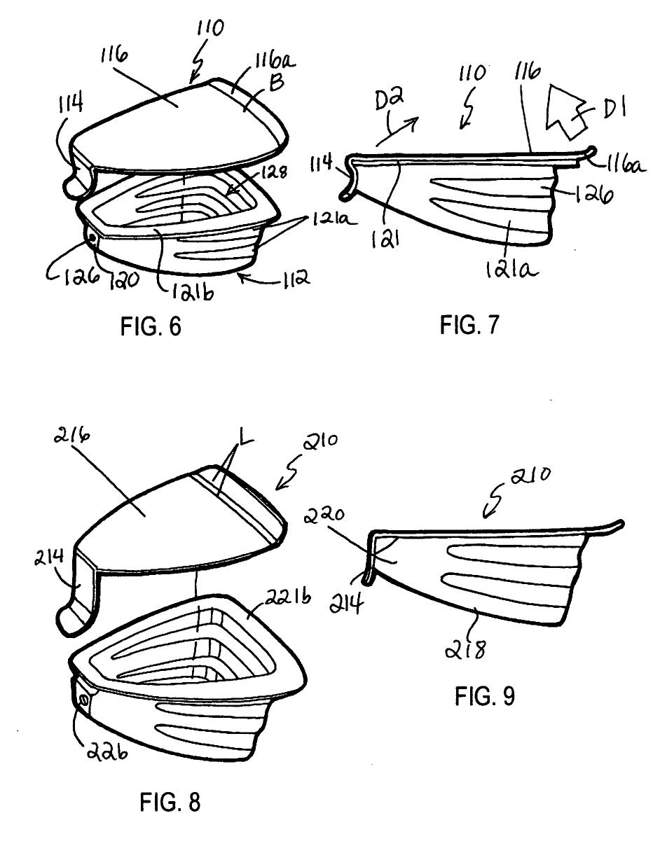

In FIGS. 6 and 7, third exemplary container 110 is shown. Container 110 includes sidewall 120 with circular first opening 126, grooves 121a and flange 121b. Grooves 121a are areas where the sidewall is locally weakened to allow body 112 to be pliant or flexible during squeeze-application mode. Grooves 121 a also provide a visual indication that container 110 can be squeezed. The size, number and shape of grooves 121a can be modified (i.e., one large groove may be preferable to several smaller grooves). Flange 121b provides a sealing surface for second lid 116. One or more of lid 116, bottom wall 118 and sidewall 120 may be flexible for the use of container 110 in the squeeze-application mode.

First opening 126 is covered by first lid 114 and flange 121b causes lid 114 to be curved. Second opening 128 is covered by second lid 116. End 116a of second lid 116 is bent along line B. End 116a can be moved in direction D1 in dipping mode to access substance in chamber 128. This will allow first lid 114 to remain in place. Alternatively, second lid 116 can be opened in direction D2 using first lid 114. Container 110 can function in squeeze-application mode or dipping mode as previously discussed with respect to container 10.

Container 110 can be reconfigured so that first opening 126 is located higher than the fill height of the condiment to help prevent leaking of the condiment if first lid 114 is removed before container 110 is used for dipping. Also, alternatively container 110 can be reconfigured with a pressure sensitive opening like first opening 26 of FIG. 1 or reconfigured to include a valve.

In FIGS. 8 and 9, fourth exemplary container 210 is shown. Container 210 includes sidewall 220 configured so that first opening 226 is in the same plane as the free end of flange 221b. As a result, first lid 214 is generally flat adjacent sidewall 220. This provides a smooth appearance to squeeze end of container 210 and may ease manufacturing. Container 210 can function in squeeze-application mode or dipping mode as previously discussed with respect to containers 10 and 110. One or more of lid 216, bottom wall 218 and sidewall 220 may be flexible for the use of container 210 in the squeeze-application mode.

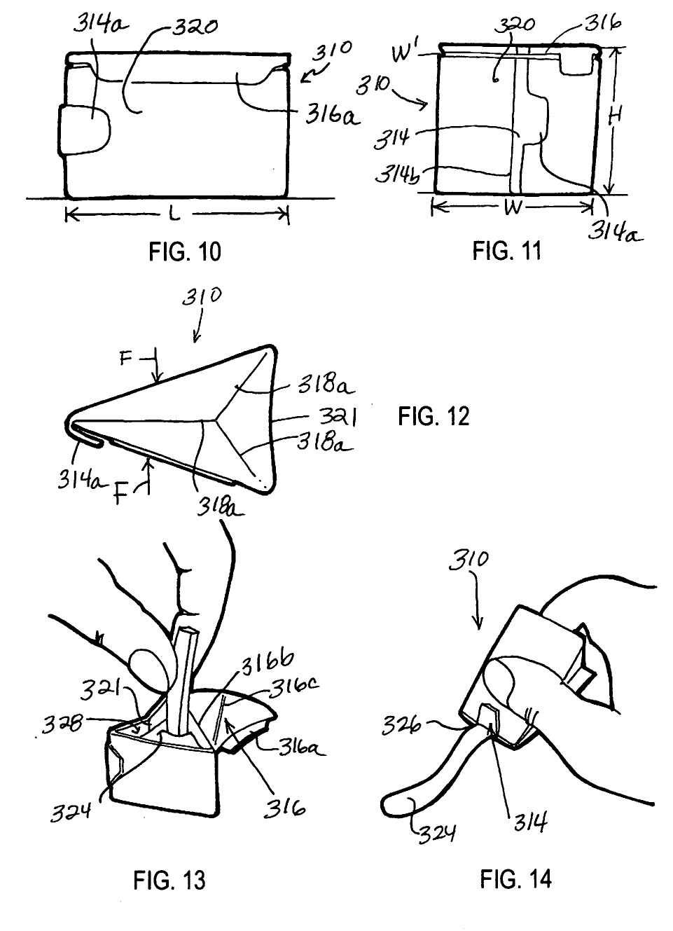

In FIGS. 10-12, fifth exemplary container 310 is shown. Container 310 includes sidewall with optional weakened area W′, as previously discussed.

Container 310 also includes first lid 314 and second Lid 316, which are separate. First lid 314 includes tab 314a for opening first lid 314. First lid 314 is joined to sidewall 320 by first hinge 314b. Second lid 316 includes tab 316a for opening second lid 316. Second lid 316 is joined to sidewall 320 by second hinge 316b (as shown in FIG. 13). Bottom wall 318 includes a plurality of creases 318a that are areas where bottom wall 318 is locally weakened to allow body 312 to be pliant or flexible during squeeze-application mode. Second lid 316 and sidewall 320 also include creases 316c and 321, respectively, for the same purpose as creases 318a. In an alternative example, fewer creases can be used.

Container 310 can function in squeeze-application mode or dipping mode as previously discussed with respect to container 10. During squeeze-application mode, first lid 314 is opened (See FIG. 14). When force F is applied to body 312 during squeeze application as shown in FIGS. 12 and 14, body 312 is compressed and substance 324 exits first opening 326. In squeeze or first mode, container 310 oriented in a first orientation (See FIG. 14) where first opening is downwardly directed and substance 324 flows from first opening 326 with the assist of the user squeezing container 10. In first mode, second opening 328 is oriented sidewardly.

During dipping mode, as shown in FIG. 13, second lid 316 is opened. First and second lids 314 and 316 are formed separately so that they can be opened independent of one another (i.e., one lid is openable while the other lid can remain closed). In dipping or second mode, container 310 is operated by opening second opening 328 and locating container 310 in second orientation (See FIG. 13) different from first orientation so that second opening 328 is upwardly oriented or extending. In second orientation, substance 324 cannot flow from second opening 328.

Referring to FIGS. 10 and 11, container 310 is dimensioned such that it has a length L of about 1.9 inches, a width W of about 1.4 inches, and a height H of about 1.25 inch. These dimensions result in container 310 having an approximate volume of about 1 ounce, which is about three times the volume of prior art foil condiment packets. These dimensions and volume are exemplary and the present container is not limited hereto and may have other dimensions or volume as designed by one of ordinary skill in the art.

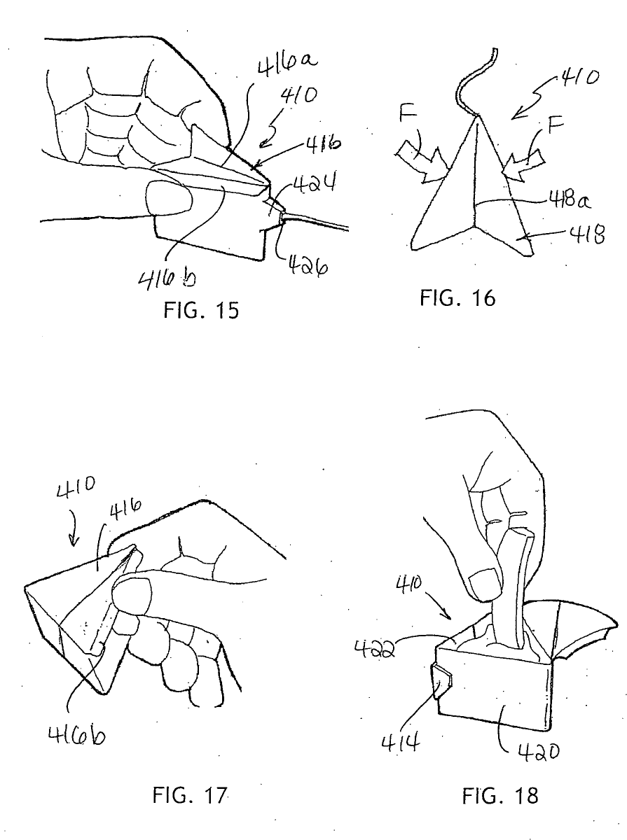

In FIGS. 15 and 16, sixth exemplary container 410 is shown. Container 410 is configured with crease 416a in second closure 416, crease 418a in bottom wall 418, and crease 421 in sidewall 420 for facilitating use in the squeeze-application mode. Container 410 also includes independent first closure or movable spout 414 and second closure or lid 416.

Container 410 can function in squeeze-application mode (shown in FIGS. 15 and 16) or dipping mode (shown in FIGS. 17 and 18) as previously discussed with respect to container 10. Spout 414 is connected to sidewall 420 and includes first opening 426. When spout 414 is in a closed position (as shown in FIG. 18), spout 414 is folded adjacent to sidewall 420. In this position, first opening 426 (see FIG. 15) is not in fluid communication with chamber 422. When spout 414 is moved into an open position (as shown in FIG. 15), spout 414 extends from sidewall 420. In this position, first opening 426 is in fluid communication with chamber 422 and forces F are applied to container 410 (as shown in FIG. 16) so that substance 424 can be squeezed out of container 410. In dipping mode, lid 416 is peeled back using tab 416a allowing access to chamber 422.

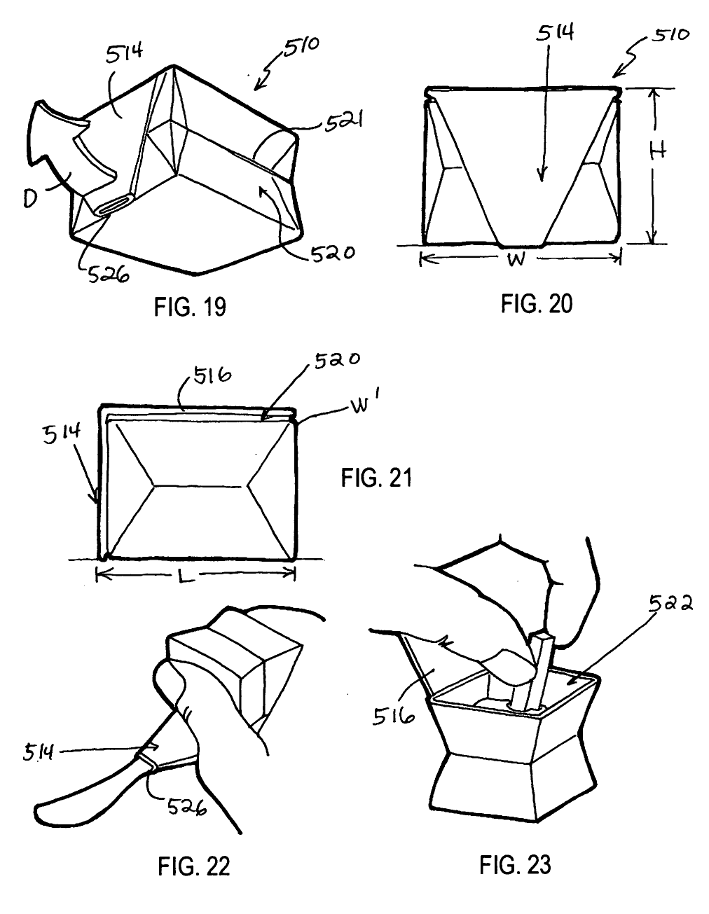

In FIGS. 19-21, seventh exemplary container 510 is shown. Container 510 has a generally box shape. Container 510 has been configured so that spout 514 is connected to sidewall 520 and spout 514 includes first opening 526. Spout 514 is intergrally formed with lid 516. Sidewall 520 includes creases 521 for facilitating use in the squeeze-application mode.

Container 510 can function in squeeze-application mode (as shown in FIG. 22) or dipping mode (as shown in FIG. 23) as previously discussed with respect to container 410. Spout 514 is moved from a closed position to an open position by moving spout 514 in direction D (see FIG. 19). In squeeze-application mode with spout 514 in an open position, first opening 526 is in fluid communication with chamber 522. In dipping mode, lid 516 is peeled back allowing access to chamber 522.

Container 510 includes sidewall with optional weakened area W′, as previously discussed.

Referring to FIGS. 20 and 21, container 510 may be dimension such that it has a length L of about 1.5 inches, a width W of about 1.5 inches, and a height H of about 1.25 inch. These dimensions result in container 510 having an approximate volume of about 1.5 ounces, which is about five times the volume of prior art foil condiment packets. These dimensions and volume are exemplary and the present container is not limited hereto and may have other dimensions or volume as designed by one of ordinary skill in the art.

Containers 310, 410 and 510 are formed of a single material, such as coated paper, rather than two different materials.

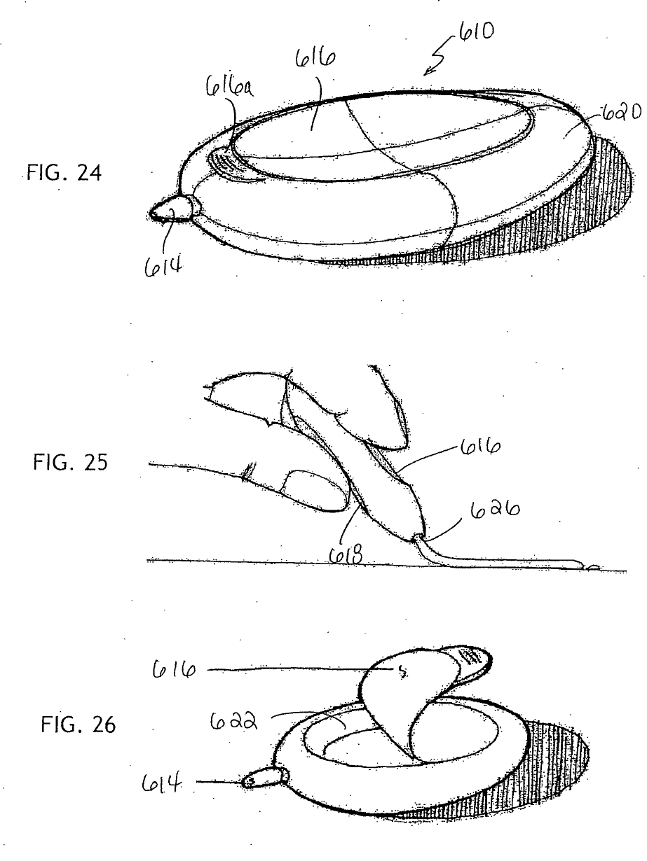

In FIGS. 24-26, eighth exemplary oval-shaped container 610 is shown. Sidewall 620 has been configured so that first opening 626 is in fluid communication with chamber 622. Container 610 includes first closure 614 and second closure or lid 616. First closure 614 is a frangible or snap-off stopper. Second lid 616 is removable and includes tab 616a for facilitating removal. Container 610 can function in squeeze-application mode (as shown in FIG. 25) or dipping mode (as shown in FIG. 26) as previously discussed. One or more of lid 616, bottom wall 618 and sidewall 620 may be flexible for the use of container 610 in the squeeze-application mode.

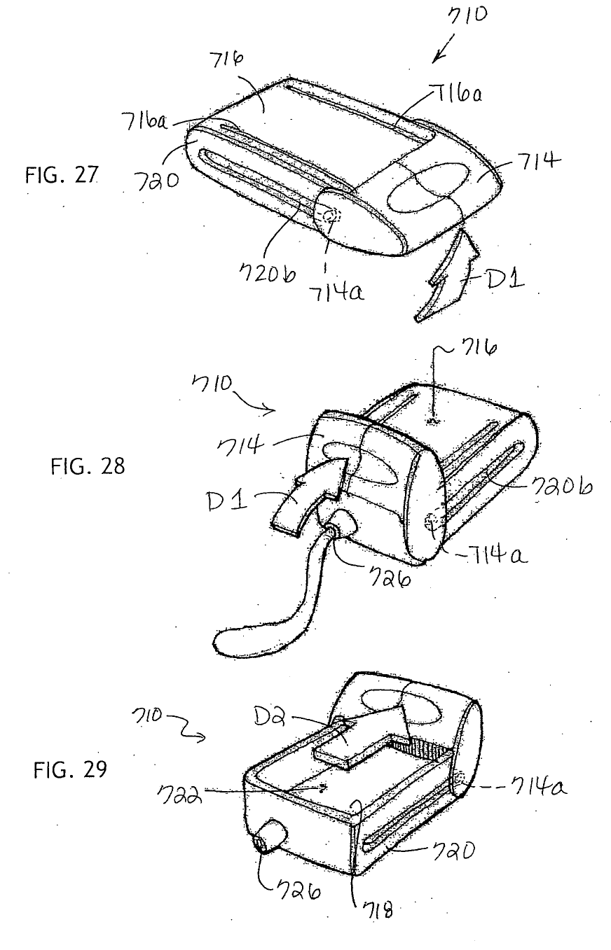

In FIGS. 27-29, ninth exemplary generally rectangular shape container 710 is shown. Sidewall 720 includes a conduit 720a and grooves 720b. Conduit 720a defines first opening 726, which is in fluid communication with chamber 722.

Container 710 further includes first closure or lid 714 and second closure or lid 716. First closure 714 is slidably connected to sidewall 720 via pins 714a (shown in phantom). Second lid 716 includes score lines 716a. Lid 714a includes projections (not shown) for cutting score lines 716a to open lid 716a by sliding lid 714 in direction D2 (as shown in FIG. 29). To open first lid 714, lid 716 is pivoted in direction D1 into open position (as shown in FIG. 28). Container 710 can function in squeeze-application mode (as shown in FIG. 28) or dipping mode (as shown in FIG. 29) as previously discussed. Second lid 716 and bottom wall 718 in this example are more flexible than sidewalls 720 to assist in squeeze-application.

First lid 714 can be configured to accept rolled up second lid 716 or second lid 716 can be peeled back adjacent first lid 714.

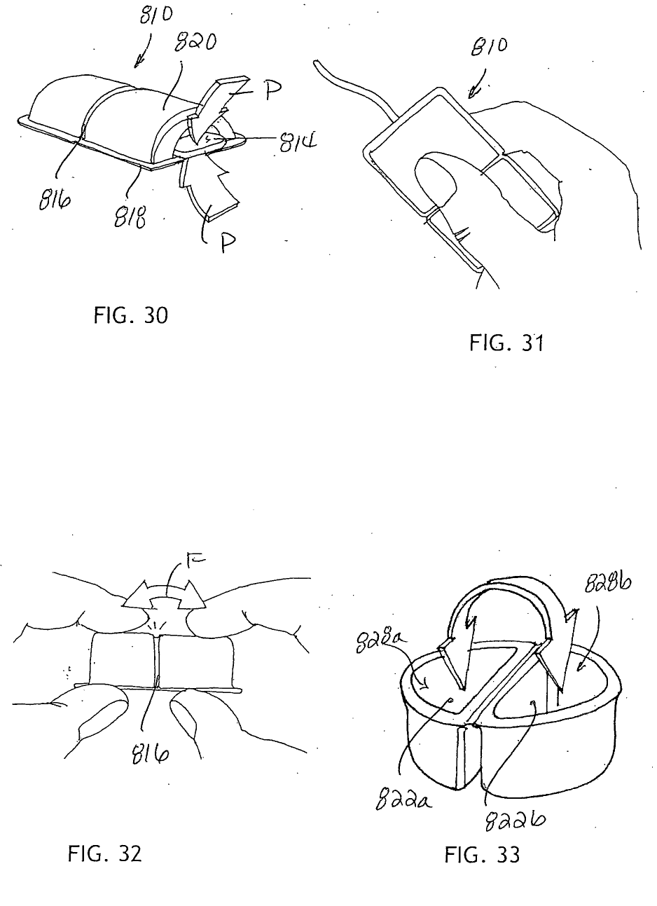

In FIG. 30, tenth exemplary container 810 is shown. Container 810 has bottom wall 818 and semi-circular sidewall 820 defining chamber 822a,b. Container 810 includes first opening (not shown) in fluid communication with chamber 822a,b. Container 810 further includes first closure 814 and second closure 816. First closure 814 is a frangible or snap-off stopper for closing first opening (not shown). Second closure or groove 816 is also frangible. Frangible closures are for one-time use and cannot be opened and closed repeatedly.

Container 810 can function in squeeze-application mode (as shown in FIG. 31) or dipping mode (as shown in FIG. 33) as previously discussed. To operate the container 810 in the squeeze-application mode, closure 814 is pinched as indicated by arrows P and twisted separate closure 814 from container 810 thus unseating first opening (not shown). Then, container 810 is compressed, as shown in FIG. 31. One or more of bottom wall 818 and sidewall 820 may be flexible for the use of container 810 in the squeeze-application mode.

In a closed position, second closure or groove 816 allows chamber portions 822a,b are in fluid communicate with one another. To open container for dipping mode, the user applies force F (see FIG. 32) on groove 816 until container 810 breaks at that location into two portions as shown in FIG. 33. As a result, chamber portion 822a and chamber portion 822b are separated (i.e., not in fluid communication with one another) and second openings 828a,b are formed for dipping.

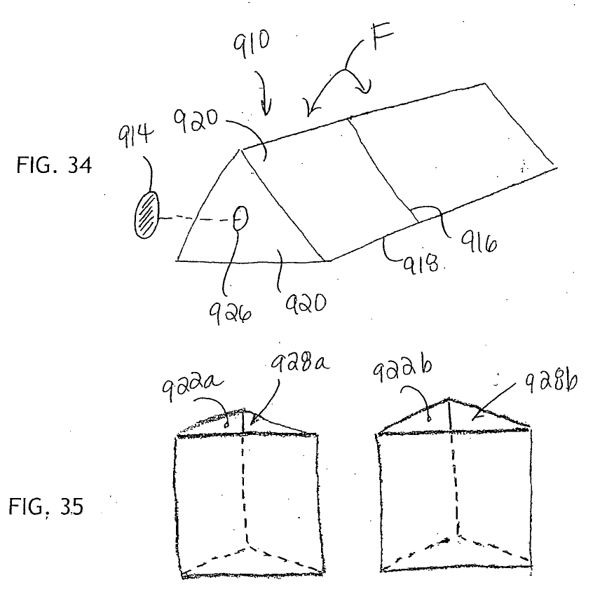

In FIGS. 34 and 35, eleventh exemplary container 910 is shown. Container 910 has sidewall 920 defining chamber 922a,b. Container 910 includes first opening 926 in fluid communication with chamber 922a,b. Container 910 further includes first closure 914 and second closure or groove 916. First closure can be any of the first closures discussed herein, such as a sticker.

The container 910 can operate in the squeeze-application mode or in a dipping mode (as shown in FIG. 35) as discussed with respect to container 810. One or more of bottom watt 918 and sidewall 920 may be flexible for the use of container 910 in the squeeze-application mode.

To open container for dipping mode, the user applies force F on groove 916 until container 910 breaks at that location into two portions as shown in FIG. 35. As a result, chamber portion 922a and chamber portion 922b are separated and second openings 928a,b are formed for dipping.

Alternatively, groove 916 can be replaced with perforations or a rip along the entire length at location of groove 916 or a portion thereof. To open such alternative container for dipping, a user rips the container along the perforated portion. Container 910 and such alternative container may be formed of foil, coated paper, low density polyethylene, or the like.

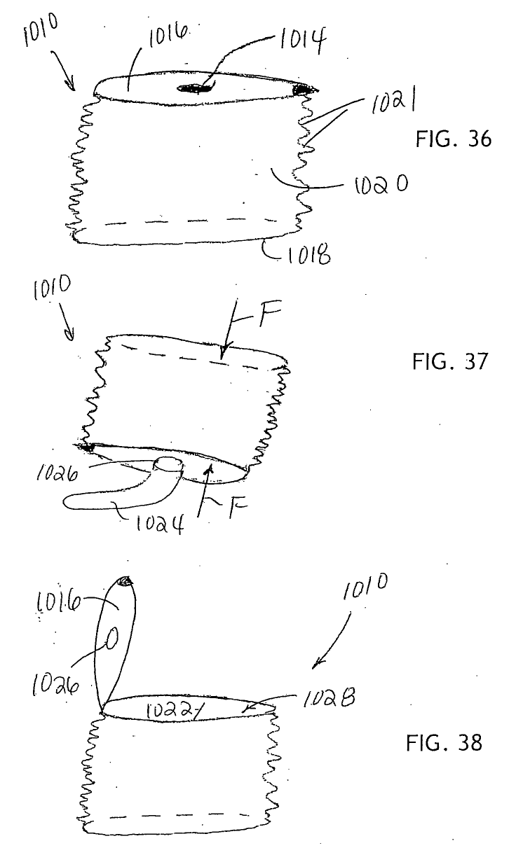

In FIGS. 36-38, twelfth exemplary container 1010 is shown. Container 1010 includes sidewall 1020 configured to include optional grooves 1021 for increasing flexibility of sidewall 1020. Container 1010 includes first and second closures or lids 1014 and 1016. First and second lids 1014 and 1016 are independently operable. One or more of lid 1016, bottom wall 1018 and sidewall 1020 may be flexible for the use of container 1010 in the squeeze-application mode.

First lid 1014 covers first opening 1026 disposed through second lid 1016. First lid is a sticker or joined to second lid 1016 by adhesive. Second lid 1016 covers second opening 1028 and is removably joined to sidewall 1020 for example by adhesive.

Container 1010 can function in squeeze-application mode (as shown in FIG. 37) or dipping mode (as shown in FIG. 38), as previously discussed with respect to container 10. To use container 1010 in squeeze-application mode, first Lid 1014 is removed from first opening 1026 and a compressive force F is applied to container 1010, as shown in FIG. 37 to eject substance 1024. To open container 1010 for dipping mode, the user peels back second lid 1016 to allow access to chamber 1022 through second opening 1028 (as shown in FIG. 38).

Alternatively, lid 1016 and bottom wall 1018 can be flexible to assist in squeeze-application. In another example, first and second lids 1014 and 1016 can be combined into a telescoping or iris-like lid. In a closed position, the iris-like lid closes first and second openings 1014 and 1016. In a first position, first opening 1014 of lid is open. In a second position, second opening 1016 larger than first opening is opened by for example rotating the lid.

In yet another example, first and second lids can be combined into a two piece lid. The lowermost piece of the lid includes an opening suitable for dipping. The uppermost piece of the lid is movable. The movable uppermost piece of the lid includes first and second openings, where the first opening is substantially smaller than second opening. The second opening is suitable for dipping and the first opening is suitable for squeeze-application. In a closed position, the openings in the uppermost lid are unaligned with the opening in the lowermost lid so that the container is closed. In a first position, the uppermost piece of the lid is moved so that the first opening is aligned with the opening in the lowermost lid. Then, the container is squeezed to eject the condiment from this smaller opening. In a second position, the uppermost piece of the lid is moved so that the second opening is aligned with the opening in the lowermost lid. Then, the food product can be dipped into the condiment.

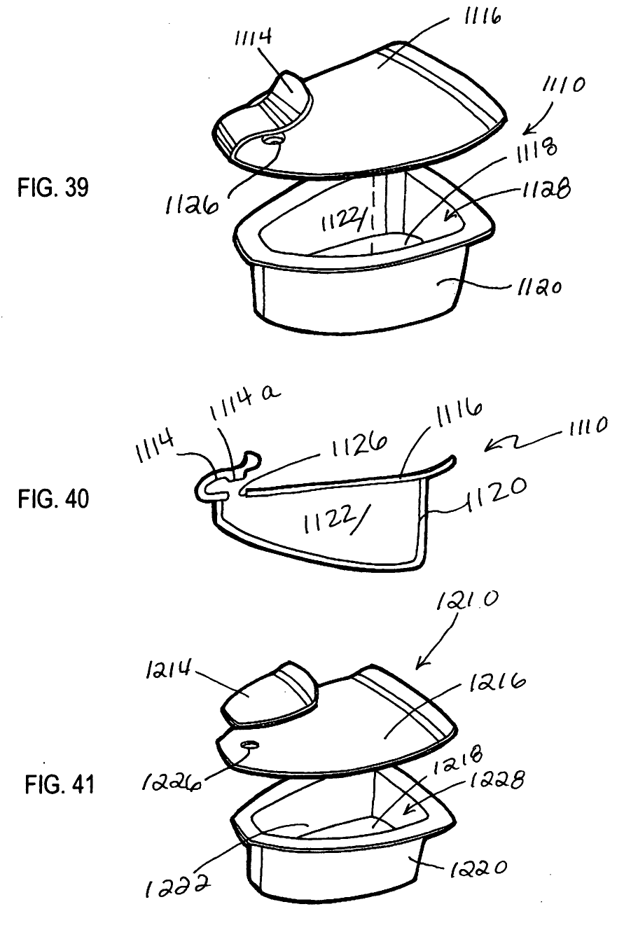

In FIG. 39, thirteenth exemplary container 1110 is shown in an exploded view. One or more of lid 1116, bottom wall 1118 and sidewall 1120 may be flexible for the use of container 1110 in the squeeze-application mode.

Container 1110 also includes first and second closures 1114 and 1116. First and second closures 1114 and 1116 are independently operable and integrally formed. First opening 1126 is disposed through second closure or lid 1116.

First closure 1114 releasably seals first opening 1126 using peg 1114a (as shown in FIG. 40). Alternatively, in an example without peg 1114a, a removable adhesive can be used to secure first closure 1114. Second lid 1116 covers second opening 1128.

Container 1110 can function in squeeze-application mode or dipping mode, as previously discussed with respect to container 10. To use container 1110 in squeeze-application mode, first lid 1114 is removed from first opening 1126 and a compressive force is applied to container. To open container 1110 for dipping mode, the user peels back second lid 1116 to allow access to chamber 1122 through second opening 1128.

In FIG. 41, fourteenth exemplary container 1210 is shown in an exploded view. One or more of lid 1216, bottom wall 1218 and sidewall 1220 may be flexible for the use of container 1210 in the squeeze-application mode.

Container 1210 also includes first and second closures 1214 and 1216. First and second closures 1214 and 1216 are independently operable and formed as separate components. First opening 1226 is disposed through second closure or lid 1216.

First closure 1214 releasably seals first opening 1226 using peg similar to peg 1114a (as shown in FIG. 40). Alternatively, in an example without peg 1114a, a removable adhesive can be used to secure first closure 1214. Second lid 1216 covers second opening 1228. First closure 1214 and second lid 1216 are formed as two separate pieces.

Container 1210 can function in squeeze-application mode or dipping mode, as previously discussed with respect to container 1110.

In FIG. 42, fifteenth exemplary container 1310 is shown. Container 1310 includes first and second closures 1314 and 1316. First and second closures 1314 and 1316 are independently operable. First opening 1326 is disposed through second closure or lid 1316.

First closure or lid 1314 releasably seals first opening 1326 and is threadably connected therein. Second lid 1316 covers second opening 1328. Second lid 1316 is connected to bottom wall 1318 using hinge 1319. Second lid 1316 is also flexible for the use of container 1310 in the squeeze-application mode. Optionally bottom wall 1318 may also be flexible for the use of container 1310 in the squeeze-application mode.

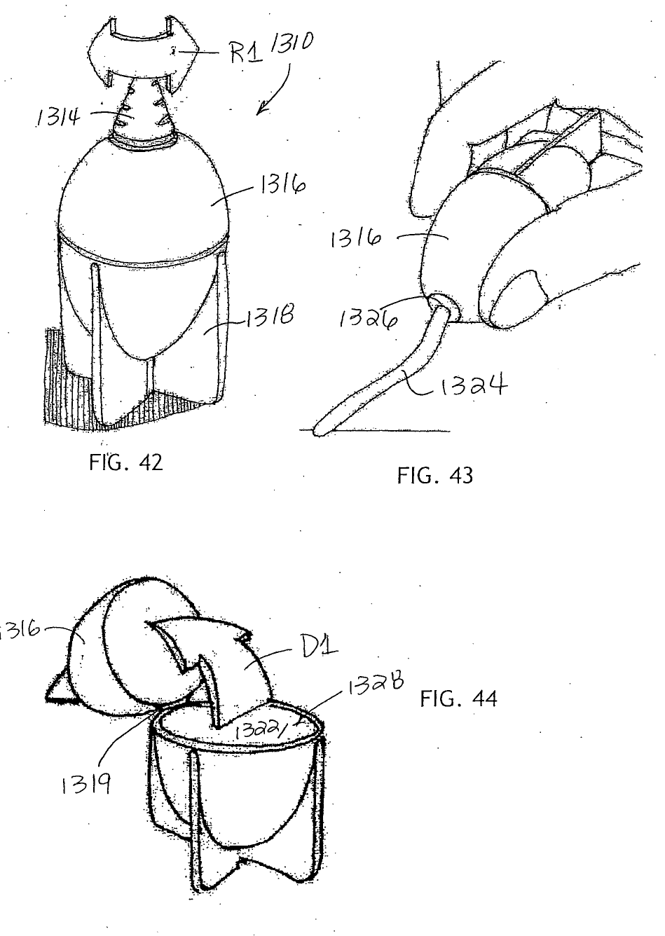

Container 1310 can function in squeeze-application mode (as shown in FIG. 43) or dipping mode (as shown in FIG. 44). To use container 1310 in squeeze-application mode, first lid 1314 is removed from first opening 1326 by rotating lid 1314 in direction R1. Then a compressive force is applied to second lid 1316 to eject substance 1324. To open container 1310 for dipping mode, the user rotates second lid 1316 back from bottom wall 1318 in direction D1 to allow access to chamber 1322 through second opening 1328.

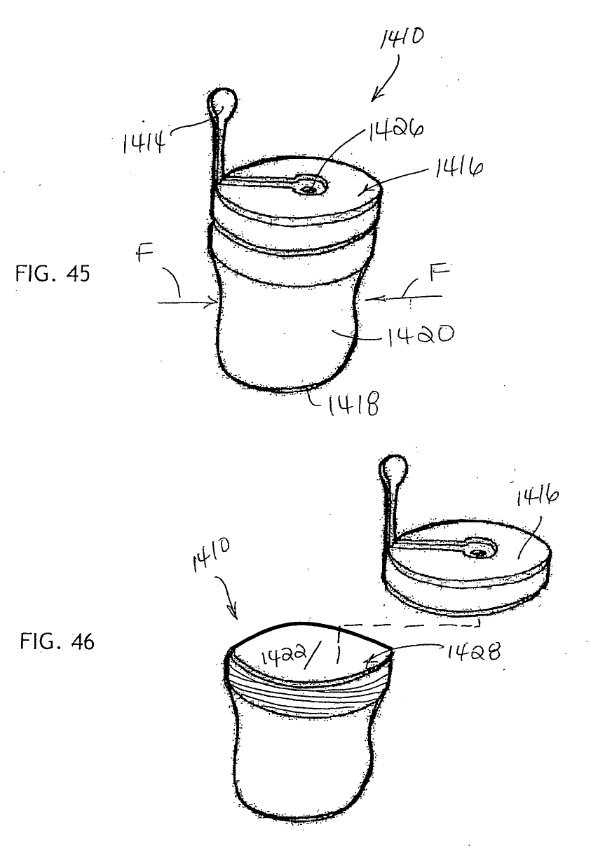

In FIGS. 45 and 46, sixteenth exemplary container 1410 is shown. Container 1410 includes first and second closures 1414 and 1416. First and second closures 1414 and 1416 are independently operable. First opening 1426 is disposed through second closure or lid 1416.

First closure or lid 1414 releasably seals first opening 1426 using a press fit and is integrally formed with second lid 1416. Second lid 1416 covers second opening 1428. Second lid 1416 is threadably connected to sidewall 1420. Alternatively, second lid 1416 can be secured to sidewall 1420 with a press fit.

In yet another alternative embodiment, container 1410 can be formed as a single continuous piece with portions joined together via peelably separable strips. By peeling the strips, first and second lids 1414 and 1416 can be removed.

Container 1410 can function in squeeze-application mode or dipping mode (as shown in FIG. 46), as previously discussed with respect to container 10. To use container 1410 in squeeze-application mode, first lid 1414 is removed from first opening 1426. Then a compressive force is applied to sidewall 1420 as shown by arrows F to eject substance. Sidewall 1420 is flexible for the use of container 1410 in the squeeze-application mode. One or more of lid 1416, bottom wall 1418 and sidewall 1420 may be flexible for the use of container 1410 in the squeeze-application mode.

To open container 1410 for dipping mode, the user unscrews second lid 1416 from sidewall 1420 to allow access to chamber 1422 through second opening 1428.

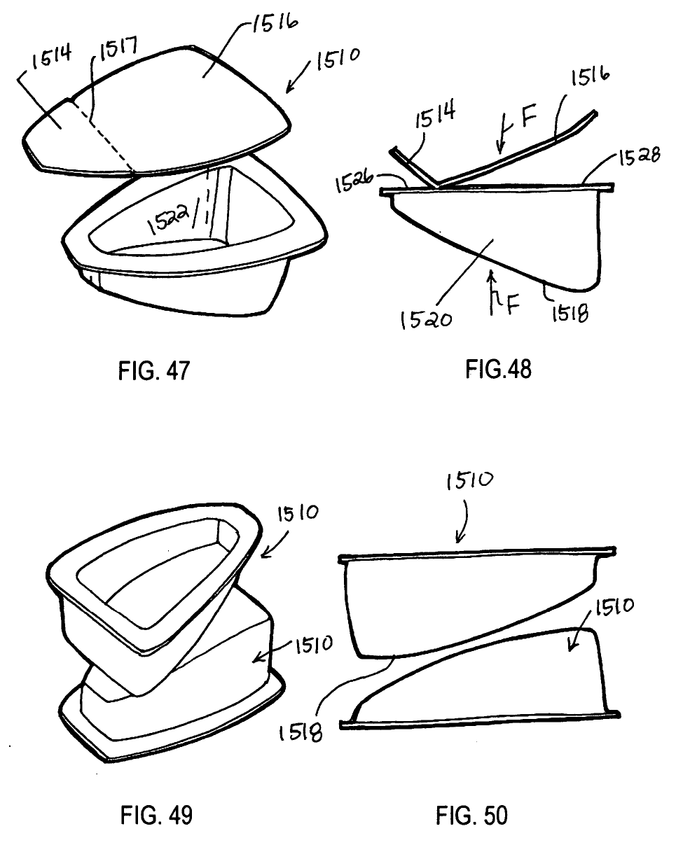

In FIGS. 47 and 48, seventeenth exemplary container 1510 is shown. Container 1510 includes first and second closures 1514 and 1516 integrally formed and divided by weakened area or crease 1517. First and second closures 1514 and 1516 are independently operable. First closure or lid 1514 and second closure or lid 1516 are located generally in one plane and sealed in one plane.

First closure or lid 1514 is operatively associated with or releasably seals first opening 1526. Second lid 1516 is operatively associated with or covers and releasably seals second opening 1528. First and second lids 1514 and 1516 are releasably connected to sidewall 1520 via for example adhesive. One or more of lid 1516, bottom wall 1518 and sidewall 1520 may be flexible for the use of container 1510 in the squeeze-application mode. Bottom wall 1518 is contoured to fit a user's open palm, and also tapered for stacking.

To use container 1510 in squeeze-application mode, first lid 1514 is removed from first opening 1526. Then a compressive force F is applied to container 1510 to eject substance. To open container 1510 for dipping mode, peels back second lid 1516 from sidewall 1520 to allow a larger access to chamber 1522 through second opening 1528.

In container 1510 (See FIG. 47), first opening 1526 is substantially smaller than second opening 1528. In container 1510, for example, first opening 1526 is about 1% to about 20% the size of second opening 1528. In container 1510, the size of first opening 1526 is generally in the upper end of the about 1% to about 20% range.

Tapering bottom wall 1518 allows containers 1510 to be easily stacked as shown in FIGS. 49 and 50. Tapering bottom wall 1518 allows two stacked containers 1510 to have a generally rectangular shape which allows for easy and efficient bulk packing into a rectangular box for shipping and also allows for easy storage of containers 1510.

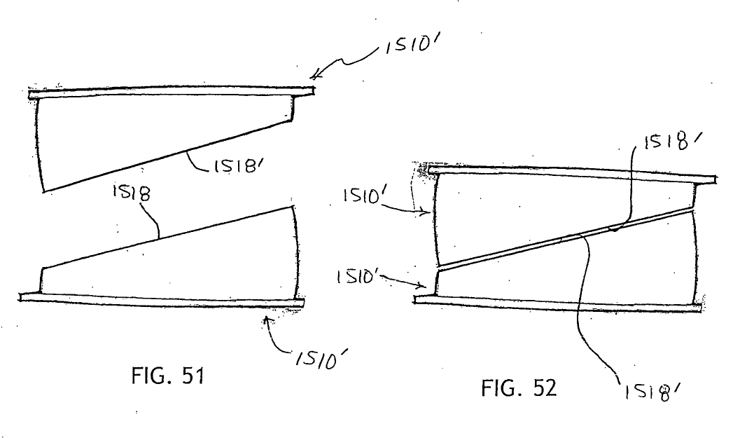

In FIGS. 51-52, eighteenth exemplary containers 1510′ are shown. Container 1510′ is similar to container 1510 except bottom wall 1518′ is straight to allow for a tighter fit of the containers during stacking (as shown in FIG. 52). Bottom, side, and top walls of container 1510′ may include registration features, such as mating mate/female elements. For example, bumps and corresponding recesses may be included in container 1510′ as registration features for stacking.

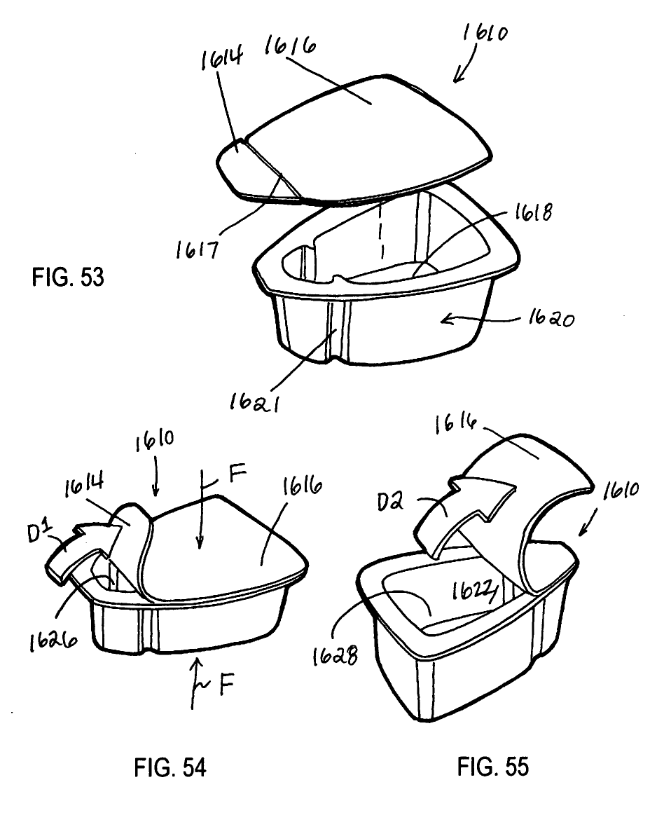

In FIGS. 53-55, ninteenth exemplary container 1610 is shown. Container 1610 includes first and second closures 1614 and 1616 integrally formed and divided by weakened area or crease 1617. First and second closures 1614 and 1616 are independently operable.

One or more of lid 1616, bottom wall 1618 and sidewall 1620 may be flexible for the use of container 1610 in the squeeze-application mode. Sidewall 1620 also includes grooves 1621 to provide a physical separation between first opening 1626 and second opening 1628. Grooves 1621 also provide a visual difference between first and second openings 1626 and 1628.

To use container 1610 in squeeze-application mode (shown in FIG. 54), first lid 1614 is peeled back from first opening 1626 in direction D1. Then a compressive force F is applied container 1610 to eject substance. To open container 1610 for dipping mode, the user peels back second lid 1616 from sidewall 1620 in direction D2 to allow access to chamber 1622 through second opening 1628.

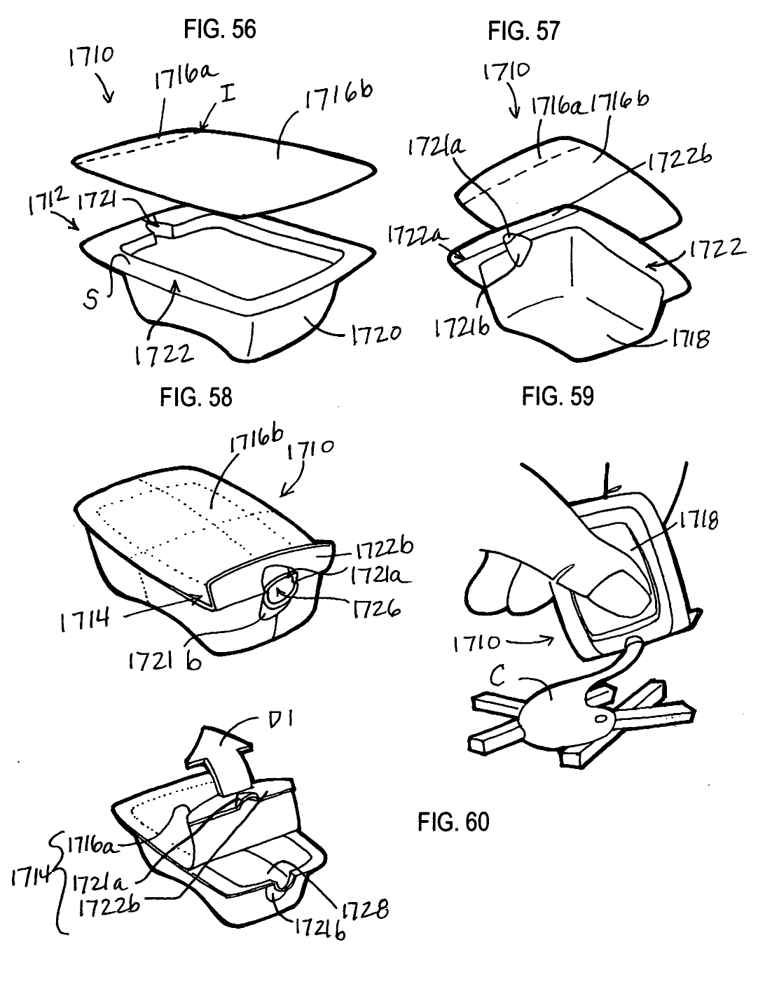

In FIGS. 56-60, twentieth exemplary container 1710 is shown. Container 1710 includes sidewall 1720 and flange 1722 extending outwardly therefrom. Spout 1721 extends outwardly from sidewall 1720 into flange 1722. Lower surface of flange 1722 includes locally weakened line 1722a that bisects spout 1721 into first spout portion 1721a and second spout portion 1721b.

Referring to FIGS. 56 and 60, first closure 1714 includes first spout portion 1721a, movable flange portion 1722b, and first lid portion 1716a. Referring to FIG. 57, first lid portion 1716a overlies spout portion 1721b, flange portion 1722b and spout portion 1721a. Weakened line 1722a can be weakened using various techniques known by those of ordinary skill in the art such as scoring or perforation.

Referring to FIG. 58, first closure 1714 is operatively associated with first opening 1726 or seats first opening 1726. Second closure 1716b is operatively associated with second opening 1728 (See FIG. 60) or seals second opening 1728. Second opening 1728 extends up to where first lid portion 1716a lies. First lid portion 1716a and second closure 1716b (i.e., second lid portion) are integrally formed from a single piece of material. As a result, the lid is formed of first lid portion 1716a and second closure or second lid portion 1716b. In addition, first lid portion 1716a and second closure 1716b extend generally in one plane for ease of manufacture. Referring to FIG. 56, spout 1721 is formed at the top of sidewall 1720 so that lid portion 1716a and second closure 1716b can be integrally formed and sealed in one plane.

Referring to FIG. 56, flange 1722 provides sealing surface S for first lid portion and second closure 1716a,b. Sealing surface S is defined where lid portion and second closure 1716a,b join body 1712. Sealing surface S is generally located in a single plane. A visible indicia I may be included between first lid portion and second closure 1716a,b to give the user a visual cue of how to open container 1710. Flange 1722 is sized so that when first lid portion and second closure 1716a,b are joined thereto, sealing surface S between these components is sufficient to retain first lid portion and second closure 1716a,b on container 1710 during squeeze mode.

One or more of first lid portion 1716a, second closure 1716b, bottom wall 1718, and sidewall 1720 may be flexible for the use of container 1710 in the squeeze-application mode (as shown in FIG. 59). Bottom wall 1718 optionally has a concave shape so that a user's thumb or index finger fits on bottom wall 1718 for ease of use.

To use container 1710 in squeeze-application mode, the user bends first closure 1714 along weakened area 1722a to separate spout portions 1721a and 1721b (as shown in FIG. 58). Thus, first opening 1726 is unsealed. User then applies force on second closure 1716b and bottom wall 1718, as shown in FIG. 59 to squeeze condiment C from within container 1710. To use container 1710 in dipping mode, the user moves closure 1714 in direction D1 (See FIG. 60) to access substance in via second opening 1728 by dipping.

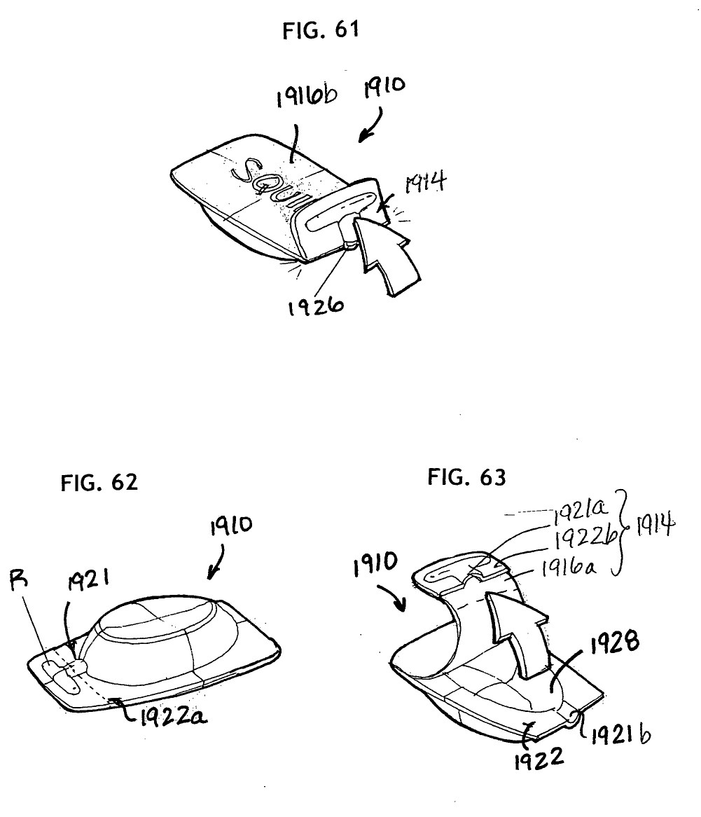

In FIGS. 61-63, twenty-first exemplary container 1910 is shown. Container 1910 is configured similarly to container 1710. Container 1910 has been configured to include spout 1921 and flange 1922.

First closure 1914 includes first spout portion 1921a, movable flange portion 1922b and first lid portion 1916a, as best seen in FIG. 63. First lid portion 1916a overlies spout portion 1921a, spout portion 1921b, and flange portion 1922b. First closure 1914 is operatively associated with first opening 1926 or seals first opening 1926. Second closure 1916b (See FIG. 61) is operatively associated with second opening 1928 (See FIG. 63) or seals second opening 1928.

Container 1910 can function in squeeze-application mode as previously discussed or dipping mode (as shown in FIG. 63). In this embodiment, weakened area 1922a bisects spout 1921 so that breaking flange 1922 along area 1922a unseals first opening 1926 (See FIG. 61). In dipping mode, second opening 1928 is accessible (See FIG. 63). Ridge R is for gripping first closure 1923.

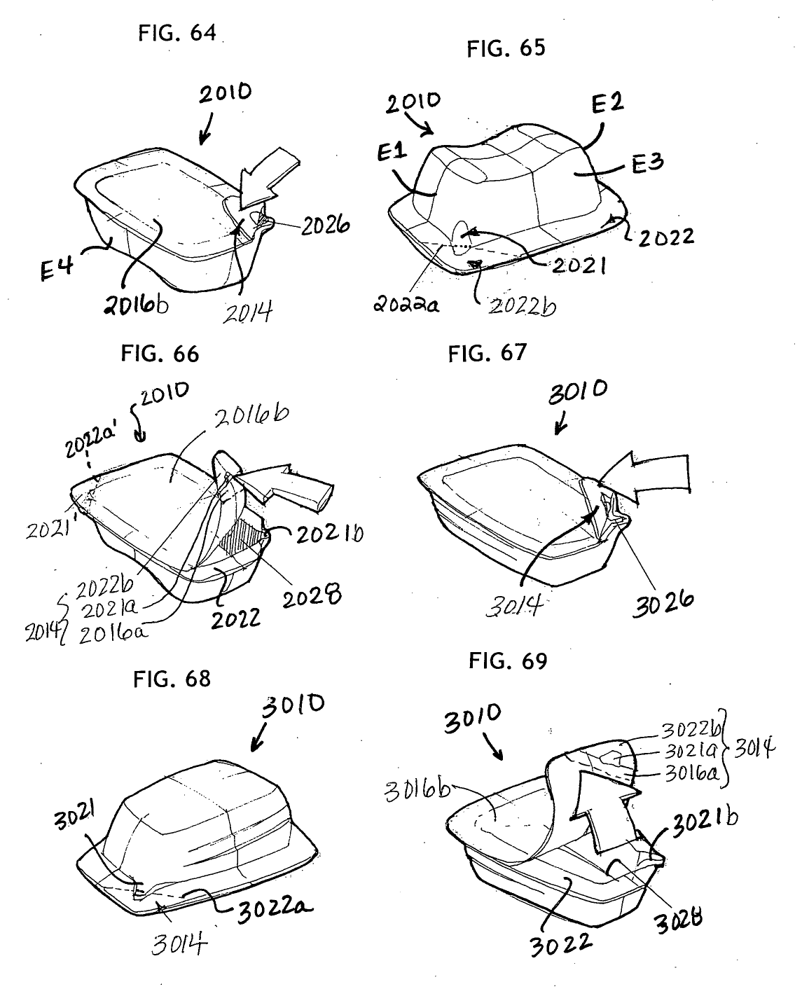

In FIGS. 64-66, twenty-second exemplary container 2010 is shown. Container 2010 is configured similarly to container 1710. Container 2010 includes spout 2021 and flange 2022. Spout 2021 is also located at a corner of container 2010. Container 2010 may include one or more grooves 52a (See FIG. 5A) in the sidewall to aid in squeezing container 2010. Container may also include grooves 121a (See FIG. 7) on sidewall ends E1 and/or E2. Container may also include grooves 121a on sidewall ends E3 and/or E4. Such grooves 121a may also circumscribe sidewall. These grooves may have a larger width near ends E1 and E2 and narrow on ends E3 and E4.

First closure 2014 includes first spout portion 2021a, movable portion 2022b of flange 2022, and first lid portion 2016a, as best seen in FIG. 69. First lid portion 2016a overlies spout portion 2021a, spout portion 2021b, and flange portion 2022b. Referring to FIG. 64, first closure 2014 is operatively associated with first opening 2026 or seals first opening 2026. Second closure 2016b (See FIG. 64) is operatively associated with second opening 2028 (See FIG. 66) or seals second opening 2028.

Container 2010 can function in squeeze-application mode as previously discussed or dipping mode (as shown in FIG. 66). In this embodiment, weakened area 2022a bisects spout 2021 so that breaking flange 2022 along area 2022a unseals first opening 2026 (See FIG. 64). In dipping mode, second opening 2028 is accessible (See FIG. 66).

Container 2010 optionally includes tab 2021′ (shown in phantom in FIG. 66) and additional weakened area 2022a′ (shown in phantom). This allows opening container 2010 for dipping at an additional corner spaced from spout portion 2021b.

In FIGS. 67-69, twenty-third exemplary container 3010 is shown. Container 3010 is configured similarly to container 2010, except spout 3021 extends to a greater extent outward along flange 3022 so that first opening 3026 forms a channel.

First closure 3014 includes first spout portion 3021 a, movable flange portion 3022b, and first lid portion 3016a, as best seen in FIG. 69. First lid portion 3016a overlies spout portion 3021b, flange portion 3022b and spout portion 3022a. First closure 3014 is operatively associated with first opening 3026 or seals first opening 3026. Referring to FIGS. 67-69, second closure 3016b is operatively associated with second opening 3028 or seals second opening 3028.

Container 3010 can function in squeeze-application mode (See FIG. 67) or dipping mode (See FIG. 69). In squeeze-application mode, first opening 3026 is accessed by breaking first closure 3014 along weakened area 3022a.

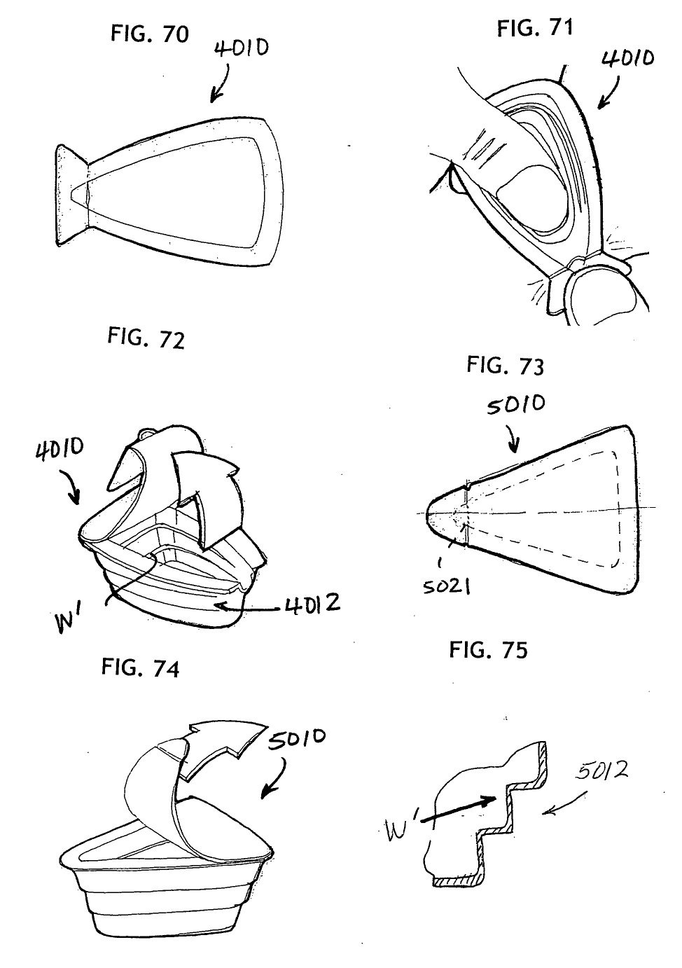

In FIGS. 70-72, twenty-fourth exemplary container 4010 is shown. Container 4010 is configured similarly to container 1710, except container 4010 has a generally triangular shape and sidewalls 4012 are optionally stepped to include weakened areas W′ similar to sidewalls 5012 discussed below. Container 4010 can function in squeeze-application mode (See FIG. 71) or dipping mode (See FIG. 72), as previously discussed.

In FIGS. 73-75, twenty-fifth exemplary container 5010 is shown. Container 5010 is configured similarly to container 4010, except container 5010 is narrowest at the end with spout 5021 (shown in phantom in FIG. 73). Sidewalls 5012 include optional weakened areas W′. These weakened areas W′ are steps in sidewalls 5012 (best shown in FIG. 75). Container 5010 can function in squeeze-application mode or dipping mode (See FIG. 74), as previously discussed.

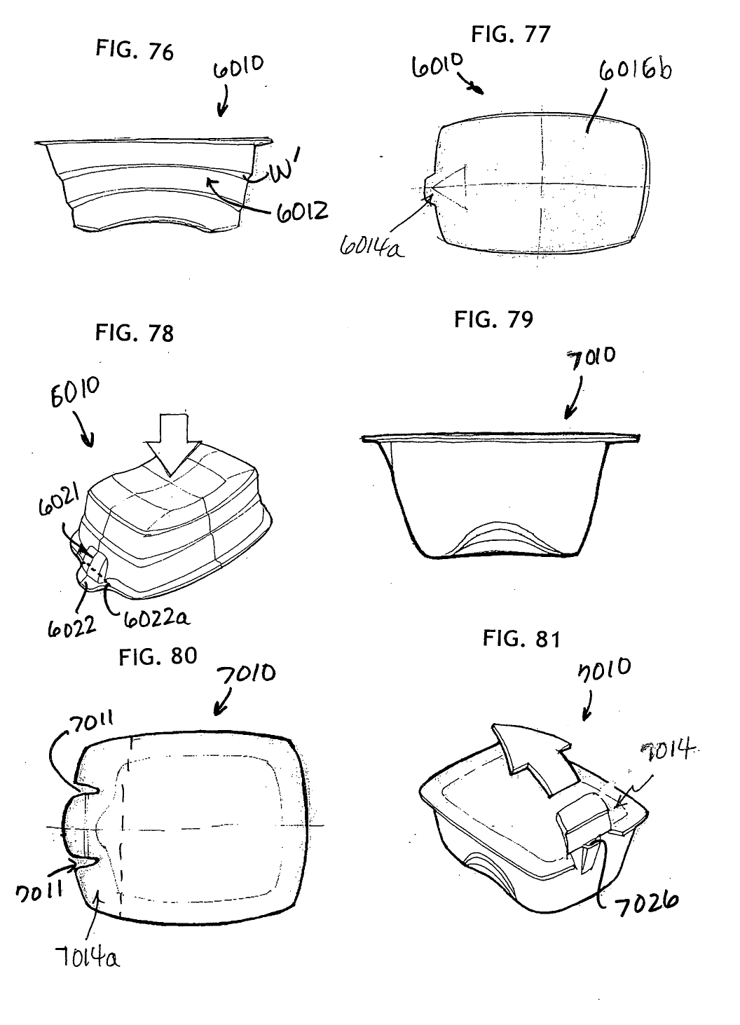

In FIGS. 76-78, twenty-sixth exemplary container 6010 is shown. Container 6010 is configured similarly to container 1710, except flange 6022 and first closure 6016a are configured to protrude adjacent to spout 6021. Spout 6021 is bisected by weakened area 6022a. Sidewalls 6012 are optionally stepped to include weakened areas W′ similar to sidewalls 5012 previously discussed. Container 6010 can function in squeeze-application mode or dipping mode, as previously discussed.

In FIGS. 79-81, twenty-seventh exemplary container 7010 is shown. Container 7010 is configured similarly to container 6010, first closure 7014 includes cutouts 7011. Container 7010 can function in squeeze-application mode (See FIG. 81), where first opening 7026 is unsealed or dipping mode as previously discussed.

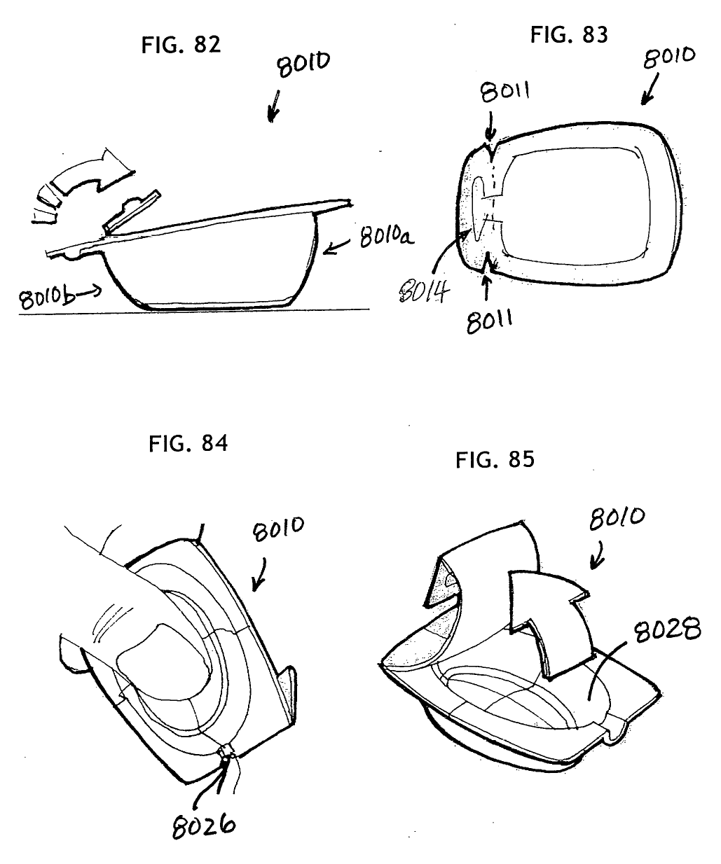

In FIGS. 82-85, twenty-eighth exemplary container 8010 is shown. Container 8010 is configured similarly to container 1910, except container 8010 is shaped to taper from end 8010a to end 8010b. First closure 8014 includes cutouts 8011. Container 8010 can function in squeeze-application mode (See FIG. 84), where first opening 8026 is unsealed or dipping mode (See FIG. 85) where second opening 8028 is unseated.

In FIGS. 86-88, twenty-ninth exemplary container 9010 is shown. Container 9010 is configured similarly to container 4010, except container 9010 has a different shape and lacks weakened areas in sidewalls 9010. However, sidewalls 9012 can be so configured. Container 9010 can function in squeeze-application mode, as previously discussed, by breaking first closure 9014 along weakened line 9022a (shown in phantom) or dipping mode (See FIG. 88) where second opening 9028 is unsealed.

In FIGS. 89-90, thirtieth exemplary container 9110 is shown. Container 9110 is configured similarly to container 2010, except container 9110 has a different shape and spout 9121 (shown in phantom) is elongated. As previously discussed, container 9110 can function in squeeze-application mode by breaking first closure 9114 along weakened line 9022a (shown in phantom) or dipping mode.

In FIGS. 91-92, thirty-first exemplary container 9210 is shown. Container 9210 is configured similarly to container 9110, except container 9210 has shortened spout 9221 (shown in phantom) that is in fluid communication with chamber 9228. As previously discussed, container 9210 can function in squeeze-application mode by breaking first closure 9214 along weakened line 9222a (shown in phantom) or dipping mode.

Those skilled in the art will appreciate that the conception, upon which this disclosure is based, may readily be utilized as a basis for designing other products. Therefore, the claims are not to be Limited to the specific examples depicted herein. For example, the features of one example disclosed above can be used with the features of another example. For example, containers, as claimed, are not limited to the materials for the body and lid or connection method described herein. For example, the shape of the containers can be modified. For example, the body of any of the examples disclosed can include weakened areas such as grooves as disclosed with respect to FIGS. 6 and 7. The size, number and shape of grooves can be modified (i.e., one large groove may be preferable to several smaller grooves). In addition, first and second openings can have various shapes sizes and locations. Additionally, the bottom wall of the container can include features to strengthen the bottom wall such as spaced apart strengthening ribs. Alternatively, the bottom wall of the container in each exemplary container can be shaped differently to improve ergonomics such as convex, concave or flat. In addition, the bottom wall of the container can include recess or other features that make the container more easily gripped. Thus, the details of these components as set forth in the above-described examples, should not limit the scope of the claims.

Further, the purpose of the Abstract is to enable the U.S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

We claim:

1. A container comprising:
a body including a bottom wall and a sidewall extending from said bottom wall, said bottom wall and sidewall defining a chamber for containing a substance and said body having first and second openings in fluid communication with said chamber, said first opening being in direct contact with said chamber and being defined in said sidewall, a portion of said body being pliant;
a first lid portion operatively associated with said first opening in a closed position; and
a second lid portion removably operatively associated with said second opening in a closed position, said first and second lid portions being formed of a single piece of material such that selective movement of said first lid portion moves said second lid portion from a closed position to an open position by peeling said second lid portion from said body;
wherein in a first mode said first lid portion is in an open position, said first opening is unsealed such that said substance flows from said first opening, and in a second mode said second lid portion is in said open position, said second opening is unsealed such that said substance is accessible in said chamber.

2. The container of claim 1 wherein in said first mode said container has a first orientation and in said second mode said container has a second orientation different from said first orientation.

3. The container of claim 2, wherein in said first mode said flow is assisted by a user squeezing said body to eject said substance.

4. The container of claim 3, wherein said body further includes a flange extending outwardly from said sidewall, and said first and second lid portions removably connected to said flange.

5. The container of claim 4, wherein said sidewall includes a weakened area to allow a lower compressive force during squeezing to evacuate said substance.

6. The container of claim 1, wherein said bottom wall and said sidewall are formed of a single piece of material.

7. The container of claim 1, wherein moving said second lid portion from said closed position to said open position occurs after moving said first lid portion from said closed position to said open position.

8. The container of claim 3, wherein said body further includes:
a spout extending outwardly from sidewall into said flange, said spout defining said first opening through said sidewall; and
a weakened area that divides a tab portion of said flange from the remainder of said flange and said weakened area divides said spout into first and second spout portions;
a first closure includes said first lid portion, said first spout portion, and said tab portion of said flange, said first closure seals said first opening in a closed position;
wherein when opening said first closure includes moving said first spout portion out of contact with said second spout portion and moving said tab portion out of contact with said remainder of said flange, when said first closure is in an open position, said first opening is unsealed such that squeezing said body ejects said substance from said first opening and when said second lid portion is in an open position, said second opening is unsealed such that said substance is accessible in said chamber.

9. The container of claim 8, wherein said sidewall includes a weakened area to allow a lower compressive force during squeezing of to evacuate said substance.

10. The container of claim 8, wherein said spout has a generally arrow shape.

11. The container of claim 1, wherein said first and second lid portions extend in one plane.

12. A container comprising:
a body including a top wall, a spaced bottom wall and a sidewall joining said top and bottom walls, said bottom wall and sidewall defining a chamber for containing a substance and said body having first and second openings in fluid communication with said chamber, a portion of said body being pliant;
a first closure which seals said first opening in a closed position; and
said top wall comprising a second closure which seals said second opening in a closed position;
wherein when said first closure is in an open position, said first opening is unseated such that squeezing said body ejects said substance from said first opening and when said second closure is in an open position, said second opening is unsealed such that said substance is accessible in said chamber.

13. The container of claim 12, wherein said first opening is in said sidewall of said body and said second opening is in said top wall of said body.

14. The container of claim 12, wherein said top wall further comprises said first closure including a lid portion, wherein said lid portion and said second closure are integrally formed.

15. The container of claim 12, wherein said body further includes a flange outwardly extending from said sidewall and a spout defining said first opening, said spout outwardly extending from said sidewall into said flange.

16. The container of claim 15, wherein said first closure includes a lid portion, a portion of said spout, and a portion of said flange.

17. The container of claim 16, wherein said lid portion and said second closure extend generally in one plane.

18. The container of claim 17, wherein a sealing surface is defined where said lid portion joins said body and where said second closure joins said body, and said sealing surface is in one plane.

19. The container of claim 15, wherein said first closure comprises a spout defining said first opening and said second closure comprises a second lid, said spout being movable between a closed position where said first opening is out of fluid communication with said chamber and an open position where said first opening is in fluid communication with said chamber.

20. The container of claim 12, wherein said substance is flowable.

21. A container comprising:
a body including a top wall, a spaced bottom wall and a sidewall joining said top and bottom walls, said bottom wall and sidewall defining a chamber for containing a substance and said body having first and second openings in fluid communication with said chamber, a portion of said body being pliant, said first opening being substantially smaller than said second opening;
a first closure which seals said first opening in a closed position; and
said top wall comprises a second closure which seals said second opening in a closed position;
wherein when said first closure is in an open position, said first opening is unsealed such that squeezing said body ejects said substance from said first opening, and when said second closure is in an open position, said second opening is unsealed such that said substance is accessible in said chamber.

22. A container for housing a condiment for use in food service and the like, said container including a dipping opening and an applicator opening, said dipping opening for dipping food products such as French fries in said condiment and said applicator opening for applying said condiment to a food product such as a hamburger, said container comprising:
a body including a top wall, a spaced bottom wall and a sidewall joining said top and bottom walls, said bottom wall and sidewall defining a chamber for containing said condiment, said body having said applicator and dipping openings in fluid communication with said chamber, a portion of said body being pliant, said applicator opening being substantially smaller than said dipping opening;
a first closure which seals said applicator opening in a closed position; and
said top wall comprising a second closure which seals said dipping opening in a closed position;
wherein when said first closure is in an open position, said applicator opening is unsealed such that squeezing said body ejects said condiment from said applicator opening, and when said second closure is in an open position, said dipping opening is unsealed such that said condiment is accessible in said chamber.
